(19) United States
(12) Patent Application Publication
(10) Pub. No.: US 2013/0080964 A1
(43) Pub. Date: Mar. 28, 2013

(54) DEVICE, METHOD, AND STORAGE MEDIUM STORING PROGRAM

(71) Applicant: KYOCERA CORPORATION, Kyoto (JP)

(72) Inventor: Saya SHIGETA, Yokohama-shi (JP)

(73) Assignee: KYOCERA CORPORATION, Kyoto (JP)

(21) Appl. No.: 13/630,085

(22) Filed: Sep. 28, 2012

(30) Foreign Application Priority Data
Sep. 28, 2011 (JP) 2011-213554
Sep. 27, 2012 (JP) 2012-215243

(51) Int. Cl. G06F 3/048

(52) U.S. Cl. 715/773

(57) ABSTRACT

According to an aspect, a device includes a touch screen display and a controller. The touch screen display displays a character input screen including a plurality of softkey objects each associated with an execution of an application. The controller executes an edit process of the plurality of softkey objects displayed on the character input screen.

### CROSS-REFERENCE TO RELATED APPLICATIONS

This application claims priority from Japanese Application No. 2011-213554, filed on Sep. 28, 2011, and Japanese Application No. 2012-215243, filed on Sep. 27, 2012, the contents of which are incorporated by reference herein in their entireties.

### BACKGROUND

1. Technical Field

The present application relates to a device, a method, and a storage medium storing therein a program. More particularly, the present application relates to a device including a touch screen display, a method of controlling the device, and a storage medium storing therein a program for controlling the device.

2. Description of the Related Art

A touch screen device having a touch screen display has been known. Examples of the touch screen devices include, but are not limited to, a smartphone and a tablet. The touch screen device detects a gesture of a finger, a pen, or a stylus pen through the touch screen display. Then, the touch screen device operates according to the detected gesture. An example of the operation according to the detected gesture is described in, for example, International Publication Pamphlet No. 2008/086302.

The basic operation of the touch screen device is implemented by an operating system (OS) built into the device. Examples of the OS built into the touch screen device include, but are not limited to, Android, BlackBerry OS, iOS, Symbian OS, and Windows Phone.

Many of the touch screen devices implement a character input function by displaying a character input screen. However, the conventional touch screen devices have some disadvantages such that character input on the character input screen can hardly work with a desired application, and therefore the improvement of customer convenience in inputting character is required of the devices.

For the foregoing reasons, there is a need for a device, a method, and a program that improve the customer convenience in inputting character.

### SUMMARY

According to an aspect, a device includes a touch screen display and a controller. The touch screen display displays a character input screen including a plurality of softkey objects each associated with an execution of an application. The controller executes an edit process of the plurality of softkey objects displayed on the character input screen.

According to another aspect, a method is for controlling a device with a touch screen display. The method includes: displaying a character input screen including a plurality of softkey objects each associated with an execution of an application on the touch screen display; and executing an edit process of the plurality of softkey objects displayed on the character input screen.

According to another aspect, a non-transitory storage medium stores therein a program. When executed by a device with a touch screen display, the program causes the device to execute: displaying a character input screen including a plurality of softkey objects each associated with an execution of an application on the touch screen display; and executing an edit process of the plurality of softkey objects displayed on the character input screen.

### BRIEF DESCRIPTION OF THE DRAWINGS

FIG. 1 is a perspective view of a smartphone according to an embodiment;

FIG. 2 is a front view of the smartphone;

FIG. 3 is a back view of the smartphone;

FIG. 4 is a diagram illustrating an example of a home screen;

FIG. 5 is a diagram illustrating an example of a lock screen;

FIG. 6 is a block diagram of the smartphone;

FIG. 7 is a flowchart illustrating an example of a character-input-screen control process of the smartphone;

FIG. 8 is a diagram illustrating an example of the character input screen;

FIG. 9 is a diagram illustrating an example of changing an arrangement of softkey objects;

FIG. 10 is a diagram illustrating an example of changing a layout in an input-character display area by executing an application;

FIG. 11 is a diagram illustrating an example of an operation screen when a text editor application is executed;

FIG. 12 is a diagram illustrating an example of an operation screen including a list of mail applications;

FIG. 13 is a flowchart illustrating an example of a character-input-screen display process;

FIG. 14 is a flowchart illustrating another example of the character-input-screen display process;

FIG. 15 is a diagram illustrating an example of the character input screen when an application is added;

FIG. 16 is a diagram illustrating an example of the character input screen when an application is deleted;

FIG. 17 is a flowchart illustrating an example of an edit-screen control process of the smartphone;

FIG. 18 is a diagram illustrating an example of an edit screen;

FIG. 19 is a diagram illustrating an example of the edit screen displaying a message indicating that the softkey object cannot be deleted;

FIG. 20 is a diagram illustrating an example of the edit screen including a trash box object; and

FIG. 21 is a diagram illustrating an example of the edit screen including an additional list and an added softkey object.

### DETAILED DESCRIPTION

Exemplary embodiments of the present invention will be explained in detail below with reference to the accompanying drawings. A smartphone will be explained below as an example of a device provided with a touch screen display.

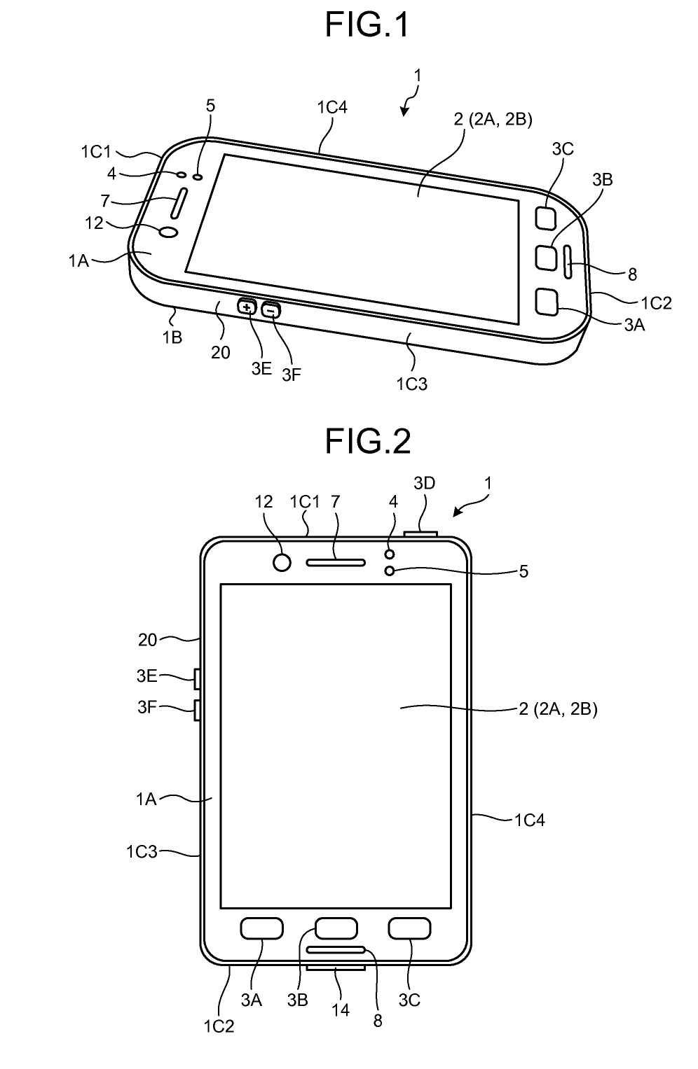

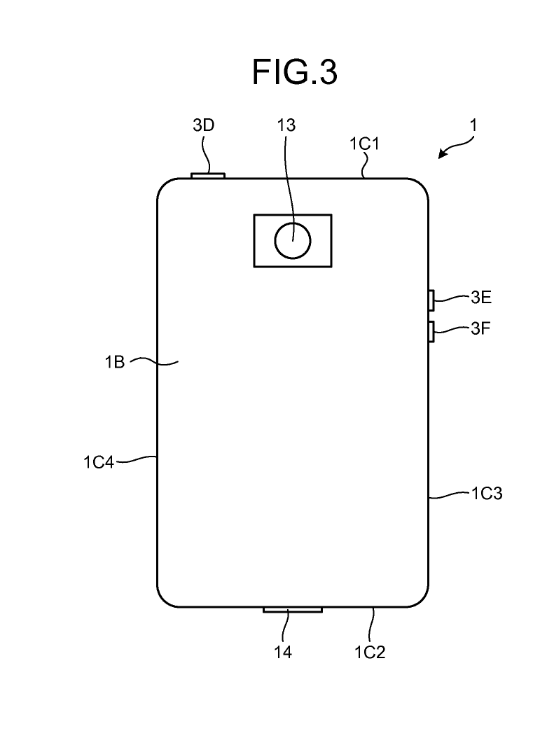

An overall configuration of a smartphone 1 according to an embodiment will be explained below with reference to FIG. 1 to FIG. 3. As illustrated in FIG. 1 to FIG. 3, the smartphone 1 includes a housing 20. The housing 20 includes a front face 1A, a back face 1B, and side faces 1C1 to 1C4. The front face 1A is a front of the housing 20. The back face 1B is a back of the housing 20. The side faces 1C1 to 1C4 are sides each connecting the front face 1A and the back face 1B. Hereinafter, the side faces 1C1 to 1C4 may be collectively called “side face 1C” without being specific to any of the side faces.

The smartphone 1 includes a touch screen display 2, buttons 3A to 3C, an illumination (ambient light) sensor 4, a proximity sensor 5, a receiver 7, a microphone 8, and a camera 12, which are provided in the front face 1A. The smartphone 1 includes a camera 13, which is provided in the back face 1B. The smartphone 1 includes buttons 3D to 3F and a connector 14, which are provided in the side face 1C. Hereinafter, the buttons 3A to 3F may be collectively called “button 3” without being specific to any of the buttons.

The touch screen display 2 includes a display 2A and a touch screen 2B. In the example of FIG. 1, each of the display 2A and the touch screen 2B is approximately rectangular-shaped; however, the shapes of the display 2A and the touch screen 2B are not limited thereto. Each of the display 2A and the touch screen 2B may have any shape such as a square, a circle or the like. In the example of FIG. 1, the display 2A and the touch screen 2B are arranged in a superimposed manner; however, the manner in which the display 2A and the touch screen 2B are arranged is not limited thereto. The display 2A and the touch screen 2B may be arranged, for example, side by side or apart from each other. In the example of FIG. 1, longer sides of the display 2A are along with longer sides of the touch screen 2B respectively while shorter sides of the display 2A are along with shorter sides of the touch screen 2B respectively; however, the manner in which the display 2A and the touch screen 2B are superimposed is not limited thereto. In case the display 2A and the touch screen 2B are arranged in the superimposed manner, they can be arranged such that, for example, one or more sides of the display 2A are not along with any sides of the touch screen 2B.

The display 2A is provided with a display device such as a liquid crystal display (LCD), an organic electro-luminescence display (GELD), or an inorganic electro-luminescence display (IELD). The display 2A displays text, images, symbols, graphics, and the like.

The touch screen 2B detects a contact of a finger, a pen, a stylus pen, or the like on the touch screen 2B. The touch screen 2B can detect positions where a plurality of fingers, pens, stylus pens, or the like make contact with the touch screen 2B. In the description herein below, a finger, pen, stylus pen, and the like may be referred to as a “contact object” or an “object”.

The detection method of the touch screen 2B may be any detection methods, including but not limited to, a capacitive type detection method, a resistive type detection method, a surface acoustic wave type (or ultrasonic type) detection method, an infrared type detection method, an electro magnetic induction type detection method, and a load sensing type detection method. In the description herein below, for the sake of simplicity, it is assumed that the user uses his/her finger(s) to make contact with the touch screen 2B in order to operate the smartphone 1.

The smartphone 1 determines a type of a gesture based on at least one of a contact detected by the touch screen 2B, a position where the contact is detected, a change of a position where the contact is detected, an interval between detected contacts, and the number of detection times of the contact. The gesture is an operation performed on the touch screen 2B. Examples of the gestures determined by the smartphone 1 include, but are not limited to, touch, long touch, release, swipe, tap, double tap, long tap, drag, flick, pinch in, and pinch out.

“Touch” is a gesture in which a finger makes contact with the touch screen 2B. The smartphone 1 determines a gesture in which the finger makes contact with the touch screen 2B as touch. “Long touch” is a gesture in which a finger makes contact with the touch screen 2B for longer than a given time. The smartphone 1 determines a gesture in which the finger makes contact with the touch screen 2B for longer than a given time as long touch.

“Release” is a gesture in which a finger separates from the touch screen 2B. The smartphone 1 determines a gesture in which the finger separates from the touch screen 2B as release. “Swipe” is a gesture in which a finger moves on the touch screen 2B with continuous contact thereon. The smartphone 1 determines a gesture in which the finger moves on the touch screen 2B with continuous contact thereon as swipe.

“Tap” is a gesture in which a touch is followed by a release. The smartphone 1 determines a gesture in which a touch is followed by a release as tap. “Double tap” is a gesture such that a gesture in which a touch is followed by a release is successively performed twice. The smartphone 1 determines a gesture such that a gesture in which a touch is followed by a release is successively performed twice as double tap.

“Long tap” is a gesture in which a long touch is followed by a release. The smartphone 1 determines a gesture in which a long touch is followed by a release as long tap. “Drag” is a gesture in which a swipe is performed from an area where a movable-object is displayed. The smartphone 1 determines a gesture in which a swipe is performed from an area where the movable-object displayed as drag.

“Flick” is a gesture in which a finger separates from the touch screen 2B while moving after making contact with the touch screen 2B. That is, “Flick” is a gesture in which a touch is followed by a release accompanied with a movement of the finger. The smartphone 1 determines a gesture in which the finger separates from the touch screen 2B while moving after making contact with the touch screen 2B as flick. The flick is performed, in many cases, with a finger moving along one direction. The flick includes “upward flick” in which the finger moves upward on the screen, “downward flick” in which the finger moves downward on the screen, “rightward flick” in which the finger moves rightward on the screen, and “leftward flick” in which the finger moves leftward on the screen, and the like. Movement of the finger during the flick is, in many cases, quicker than that of the finger during the swipe.

“Pinch in” is a gesture in which a swipe with a plurality of fingers is performed in a direction to move the fingers toward each other. The smartphone 1 determines a gesture in which the distance between a position of one finger and a position of another finger detected by the touch screen 2B becomes shorter as pinch in. “Pinch out”is a gesture in which a swipe with a plurality of fingers is performed in a direction to move the fingers away from each other. The smartphone 1 determines a gesture in which the distance between a position of one finger and a position of another finger detected by the touch screen 2B becomes longer as pinch out.

In the description herein below, a gesture performed by using a finger may be referred to as a “single touch gesture”, and a gesture performed by using a plurality of fingers may be referred to as a “multi touch gesture”. Examples of the multi touch gesture include a pinch in and a pinch out. A tap, a flick, a swipe, and the like are a single touch gesture when performed by using a finger, and are a multi touch gesture when performed by using a plurality of fingers.

The smartphone 1 performs operations according to these gestures which are determined through the touch screen 2B. Therefore, user-friendly and intuitive operability is achieved. The operations performed by the smartphone 1 according to the determined gestures may be different depending on the screen displayed on the display 2A. In the following explanation, for the sake of simplicity of explanation, the fact that the touch screen detects the contact(s) and then the smartphone determines the type of the gesture as X based on the contact(s) may be simply described as “the smartphone detects X” or “the controller detects X”.

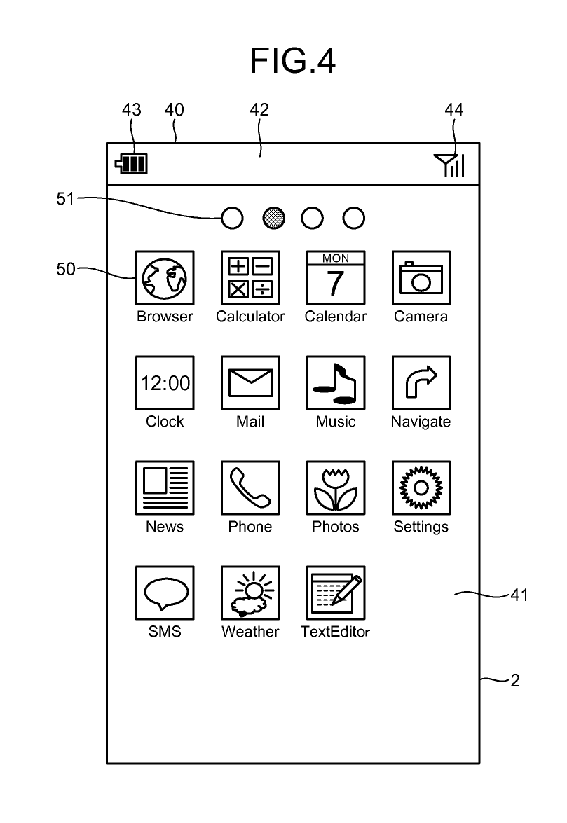

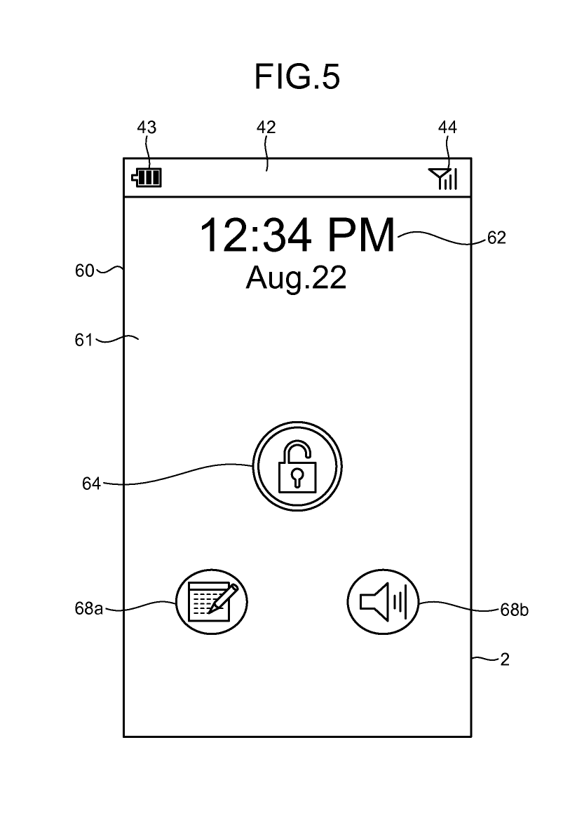

An example of the screen displayed on the display 2A will be explained below with reference to FIGS. 4 and 5. First of all, an example of a home screen will be explained with reference to FIG. 4. FIG. 4 represents an example of a home screen. The home screen may also be called “desktop”, “standby screen”, “idle screen”, or “standard screen”. The home screen is displayed on the display 2A. The home screen is a screen allowing the user to select which one of applications (programs) installed in the smartphone 1 is executed. The smartphone 1 executes the application selected on the home screen in the foreground. The screen of the application executed in the foreground is displayed on the display 2A.

Icons can be arranged on the home screen of the smartphone 1. A plurality of icons 50 are arranged on a home screen 40 illustrated in FIG. 4. Each of the icons 50 is previously associated with an application installed in the smartphone 1. When detecting a gesture for an icon 50, the smartphone 1 executes the application associated with the icon 50 for which the gesture is detected. For example, when detecting a tap on an icon 50 associated with a mail application, the smartphone 1 executes the mail application. For example, when detecting a tap on an icon 50 associated with a character input application, the smartphone 1 executes the character input application.

The icons 50 include an image and a character string. The icons 50 may contain a symbol or a graphic instead of an image. The icons 50 do not have to include either one of the image and the character string. The icons 50 are arranged based on a layout pattern. A wall paper 41 is displayed behind the icons 50. The wall paper may sometimes be called “photo screen”, “back screen”, “idle image”, or “background image”. The smartphone 1 can use an arbitrary image as the wall paper 41. The smartphone 1 may be configured so that the user can select an image to be displayed as the wall paper 41.

The smartphone 1 can include a plurality of home screens. The smartphone 1 determines, for example, the number of home screens according to setting by the user. The smartphone 1 displays a selected one on the display 2A even if there is a plurality of home screens.

The smartphone 1 displays an indicator (a locator) 51 on the home screen. The indicator 51 includes one or more symbols. The number of the symbols is the same as that of the home screens. In the indicator 51, a symbol corresponding to a home screen that is currently displayed is displayed in a different manner from that of symbols corresponding to the other home screens.

The indicator 51 in an example illustrated in FIG. 4 includes four symbols. This means the number of home screens is four. According to the indicator 51 in the example illustrated in FIG. 4, the second symbol from the left is displayed in a different manner from that of the other symbols. This means that the second home screen from the left is currently displayed.

The smartphone 1 can change a home screen to be displayed on the display 2A. When a gesture is detected while displaying one of home screens, the smartphone 1 changes the home screen to be displayed on the display 2A to another one. For example, when detecting a rightward flick, the smartphone 1 changes the home screen to be displayed on the display 2A to a home screen on the left side. For example, when detecting a leftward flick, the smartphone 1 changes the home screen to be displayed on the display 2A to a home screen on the right side. The smartphone 1 changes the home screen to be displayed on the display 2A from a first home screen to a second home screen, when a gesture is detected while displaying the first home screen, such that the area of the first home screen displayed on the display 2A gradually becomes smaller and the area of the second home screen displayed gradually becomes larger. The smartphone 1 may switch the home screens such that the first home screen is instantly replaced by the second home screen.

An area 42 is provided along the top edge of the display 2A. Displayed on the area 42 are a remaining mark 43 indicating a remaining amount of a power supply and a radio-wave level mark 44 indicating an electric field strength of radio wave for communication. The smartphone 1 may display time, weather, an application during execution thereof, a type of communication system, a status of a phone call, a mode of the device, an event occurring in the device, and the like in the area 42. In this manner, the area 42 is used to inform the user of various notifications. The area 42 may be provided on any screen other than the home screen 40. A position where the area 42 is provided is not limited to the top edge of the display 2A.

The home screen 40 illustrated in FIG. 4 is only an example, and therefore the configuration of each of elements, the arrangement of the elements, the number of home screens 40, the way to perform each of operations on the home screen 40, and the like do not have to be like the above mentioned explanation.

Then, an example of a lock screen will be explained with reference to FIG. 5. FIG. 5 is a diagram illustrating an example of the lock screen. The lock screen is displayed on the display 2A while its locked status is set, that is, while setting of the locked status is ON. A lock screen 60 is a screen indicating that the locked status is set. The lock screen 60 detects a preset unlock gesture to shift to another screen. In other words, the lock screen 60 is a screen in which any gesture other than a preset gesture is determined as invalid. The smartphone 1 is configured not to perform various operations until the preset unlock gesture is detected on the lock screen.

Arranged in the lock screen 60 illustrated in FIG. 5 are a date/time image 62, a key icon 64, and application icons 68a and 68b on a wallpaper 61. The lock screen 60 has an area 42, which is the same as the area 42 of the home screen 40, arranged along the top edge of the display 2A. The lock screen 60 displays a remaining mark 43 indicating a remaining amount of a power supply and a radio-wave level mark 44 indicating an electric field strength of radio wave for communication on the area 42. The wallpaper 61 is displayed behind the date/time image 62, the key icon 64, and the application icons 68a and 68b.

The date/time image 62 is an image indicating time and date, which appears in an area located in an upper portion of the lock screen 60 and below the area 42. The date/time image 62 illustrated in FIG. 5 represents “12:34 PM” which is a status display indicating a time 12 o'clock and 34 minutes in the afternoon and “Aug. 22” which is a status display indicating a date 22nd, August.

The key icon 64 is an image resembling a key, which appears in a substantially central portion of the screen. The user performs a flick on the key icon 64 to unlock. When detecting the flick performed on the key icon 64, the smartphone 1 releases the locked status and displays, for example, the home screen 40 on the display 2A.

The application icons 68a and 68b appear in a lower portion of the screen. Each of the application icons 68a and 68b is associated with an application installed into the smartphone 1. When detecting a flick performed on the application icon 68a or 68b, the smartphone 1 executes the application associated with the application icon.

In the example of FIG. 5, the application icon 68a is associated with a character input application. The application icon 68b is associated with a volume control application. Each of the application icons 68a and 68b includes an image indicating a corresponding application. The application icons 68a and 68b may include an image and text similarly to the icons 50, and may include a symbol or a graphic instead of an image. The application icons 68a and 68b may be formed with only a character string without any image.

The lock screen 60 illustrated in FIG. 5 is only an example, and therefore the configuration of each of elements, the arrangement of the elements, the way to perform each of operations on the lock screen 60, and the like do not have to be like the above mentioned explanation.

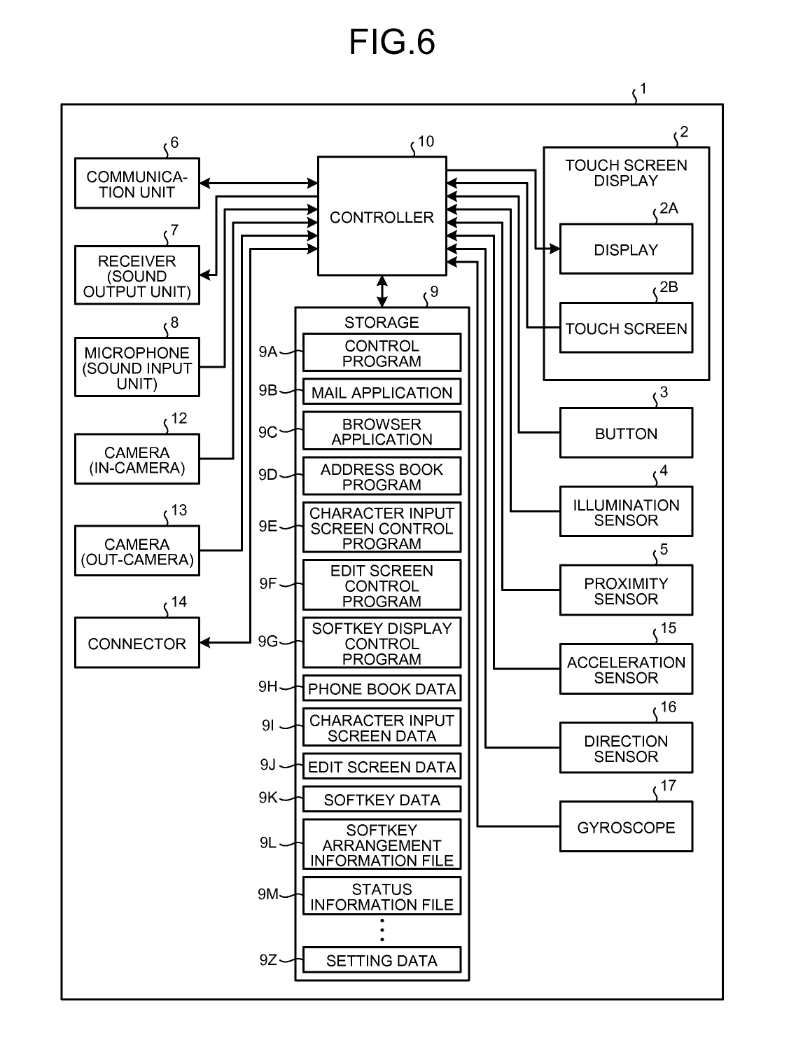

FIG. 6 is a block diagram of the smartphone 1. The smartphone 1 includes the touch screen display 2, the button 3, the illumination sensor 4, the proximity sensor 5, a communication unit 6, the receiver 7, the microphone 8, a storage 9, a controller 10, the cameras 12 and 13, the connector 14, an acceleration sensor 15, a direction (orientation) sensor 16, and a gyroscope 17.

The touch screen display 2 includes, as explained above, the display 2A and the touch screen 2B. The display 2A displays text, images, symbols, graphics, or the like. The touch screen 2B detects contact(s). The controller 10 detects a gesture performed for the smartphone 1. Specifically, the controller 10 detects an operation (a gesture) for the touch screen 2B in cooperation with the touch screen 2B.

The button 3 is operated by the user. The button 3 includes buttons 3A to 3F. The controller 10 detects an operation for the button 3 in cooperation with the button 3. Examples of the operations for the button 3 include, but are not limited to, a click, a double click, a triple click, a push, and a multi-push.

The buttons 3A to 3C are, for example, a home button, a back button, or a menu button. The button 3D is, for example, a power on/off button of the smartphone 1. The button 3D may function also as a sleep/sleep release button. The buttons 3E and 3F are, for example, volume buttons.

It is assumed that the button 3A is assigned to a back button, the button 3B is assigned to a home button, and the button 3C is assigned to a menu button. In this case, when detecting an operation for the button 3C, the smartphone 1 displays a menu of the applications. Then, when detecting an operation for selecting an application, such as a mail application, from the menu, the smartphone 1 executes the corresponding application. When detecting an operation for the button 3B while a screen of the executed application is displayed, the smartphone 1 stops displaying the screen while executing the application in the background. Then, when detecting an operation for the button 3C and an operation for selecting the same application again, the smartphone 1 executes the application, which has been executed in the background, in the foreground and displays the screen of the application. Meanwhile, when detecting an operation for the button 3A while a screen of the executed application is displayed, the smartphone 1 stops executing the application and displaying the screen of the application. Then, when detecting an operation for the button 3C and an operation for selecting the same application again, the smartphone 1 newly executes the application and displays the screen of the executed application.

The illumination sensor 4 detects illumination of the ambient light of the smartphone 1. The illumination indicates intensity of light, lightness, or brightness. The illumination sensor 4 is used, for example, to adjust the brightness of the display 2A. The proximity sensor 5 detects the presence of a nearby object without any physical contact. The proximity sensor 5 detects the presence of the object based on a change of the magnetic field, a change of the return time of the reflected ultrasonic wave, etc. The proximity sensor 5 detects that, for example, the touch screen display 2 is brought close to someone's face. The illumination sensor 4 and the proximity sensor 5 may be configured as one sensor. The illumination sensor 4 can be used as a proximity sensor.

The communication unit 6 performs communication via radio waves. A communication system supported by the communication unit 6 is wireless communication standard. The wireless communication standard includes, for example, a communication standard of cellar phones such as 2G, 3G, and 4G. The communication standard of cellar phones includes, for example, Long Term Evolution (LTE), Wideband Code Division Multiple Access (W-CDMA), CDMA 2000, a Personal Digital Cellular (PDC), a Global System for Mobile Communications (GSM), and a Personal Handy-phone System (PHS). The wireless communication standard further includes, for example, Worldwide Interoperability for Microwave Access (WiMAX), IEEE 802.11, Bluetooth, Infrared Data Association (IrDA), and Near Field Communication (NFC). The communication unit 6 may support one or more communication standards. The communication unit 6 may support wired communication. Examples of the wired communication include Ethernet, Fibre Channel, etc.

The receiver 7 is a sound output unit. The receiver 7 outputs a sound signal transmitted from the controller 10 as sound. The receiver 7 is used, for example, to output voice of the other party on the phone. The smartphone 1 may include a speaker in addition to, or in stead of, the receiver 7. The microphone 8 is a sound input unit. The microphone 8 converts speech of the user or the like to a sound signal and transmit the converted signal to the controller 10.

The storage 9 stores therein programs and data. The storage 9 is used also as a work area that temporarily stores a processing result of the controller 10. The storage 9 may include any non-transitory storage medium such as a semiconductor storage medium and a magnetic storage medium. The storage 9 may include a plurality type of storage mediums. The storage 9 may include a combination of a portable storage medium such as a memory card, an optical disc, or a magneto-optical disc with a reader of the storage medium. The storage 9 may include a storage device used as a temporary storage area such as Random Access Memory (RAM).

Programs stored in the storage 9 include applications executed in the foreground or the background and a control program for assisting operations of the applications. The application causes the controller 10, for example, to display a screen on the display 2A and perform a process according to a gesture detected through the touch screen 2B. The control program is, for example, an OS. The applications and the control program may be installed in the storage 9 through communication by the communication unit 6 or through a non-transitory storage medium.

The storage 9 stores therein, for example, a control program 9A, a mail application 9B, a browser application 9C, an address book program 9D, a character-input-screen control program 9E, an edit-screen control program 9F, a softkey display control program 9G, address book data 9H, character-input-screen data 9I, edit screen data 9J, softkey data 9K, a softkey arrangement information file 9L, a status information file 9M, and setting data 9Z.

The control program 9A provides a function related to various controls for operating the smartphone 1. The control program 9A controls, for example, the communication unit 6, the receiver 7, and the microphone 8 to make a phone call. The function provided by the control program 9A includes functions for performing various controls such as changing a screen displayed on the display 2A according to the detected gesture through the touch screen 2B. The functions provided by the control program 9A can be used in combination with a function provided by the other program such as the mail application 9B.

The mail application 9B provides an e-mail function for composing, transmitting, receiving, and displaying e-mail, and the like. The browser application 9C provides a WEB browsing function for displaying WEB pages. The address book program 9D provides an address book function for browsing, searching, registering, and deleting an address book, and the like. The character-input-screen control program 9E provides various functions for controlling the character input screen to implement a character input function. The character-input-screen control program 9E also provides various functions for controlling the character input screen to implement the character input application. The character input screen is a screen displayed when an operation for executing the character input application is input by the user and the character input application is executed. Examples of the operation for executing the character input application include, but are not limited to, a click on the button 3, a touch on a predetermined icon displayed on the home screen or the lock screen, etc. The character input screen includes an input-character display area for displaying input character, a softkey display area for displaying part of a plurality of softkey objects arranged in a row, and a keyboard area for inputting text. The softkey objects are associated with executions of applications respectively. The execution of an application includes an execution of an application that can work with character input on the character input screen and an execution of a process executable by the application. The character-input-screen control program 9E provides, for example, a function for displaying input character in the input-character display area of the character input screen based on a character input operation detected in the keyboard area of the character input screen.

The edit-screen control program 9F provides various functions for controlling an edit screen to implement an edit function for softkey objects displayed on the character input screen. The edit screen includes a plurality of softkey objects corresponding to the softkey objects to be included in the character input screen respectively. The edit screen includes, similarly to the character input screen, a softkey display area for displaying part of the softkey objects arranged in a row. The softkey display control program 9G provides a softkey display function for displaying the softkey objects. The softkey display control program 9G also provides a function for displaying softkey objects in the softkey display area of the character input screen and the edit screen, a function for executing the application associated with the softkey object included in the character input screen, and a function for changing a configuration of the softkey objects displayed in the softkey display area of the character input screen and the edit screen, and the like. The softkey display control program 9G provides a function for reflecting the execution result of an edit process executed on the edit screen in the softkey objects included in the edit screen and in the softkey objects included in the character input screen. The edit process includes at least one of addition, deletion, and rearrangement of softkey objects to be displayed on the character input screen.

The address book data 9H includes data such as registered names, phone numbers, and mail addresses which are used when the address book program 9D is executed. The character-input-screen data 9I includes various text data and image data displayed by executing the character-input-screen control program 9E. The character-input-screen data 9I includes data such as text data displayed in the input-character display area and image data for keyboard objects displayed in the keyboard area. The edit screen data 9J includes various text data and image data displayed by executing the edit-screen control program 9F. The softkey data 9K includes various text data or image data displayed by executing the softkey display control program 9G. The softkey data 9K includes data such as text data and image data indicating with which of the applications a softkey object is associated.

The softkey arrangement information file 9L is an arrangement-information storage means that stores therein arrangement information for softkey objects displayed in the softkey display area on the character input screen and the edit screen. The arrangement information is position data indicating an arrangement of the softkey objects displayed in the softkey display area. When the application corresponding to the softkey object selected by the user is executed, the controller 10 stores the position data of each of the softkey objects displayed in the softkey display area in the softkey arrangement information file 9L. The status information file 9M is a status-information storage means that stores therein status information for the applications provided in the smartphone 1. The status information is list data indicating a status such as addition or deletion of each of the applications. When an application is, for example, added or deleted, the controller 10 updates the status information stored in the status information file 9M. The setting data 9Z includes information related to various settings on the operations of the smartphone 1.

The controller 10 is a processing unit. Examples of the processing units include, but are not limited to, a Central Processing Unit (CPU), System-on-a-chip (SoC), a Micro Control Unit (MCU), and a Field-Programmable Gate Array (FPGA). The controller 10 integrally controls the operations of the smartphone 1 to implement various functions.

Specifically, the controller 10 executes instructions contained in the program stored in the storage 9 while referring to the data stored in the storage 9 as necessary. The controller 10 controls a function unit according to the data and the instructions to thereby implement the various functions. Examples of the function units include, but are not limited to, the display 2A, the communication unit 6, and the receiver 7. The controller 10 can change the control of the function unit according to the detection result of a detector. Examples of the detectors include, but are not limited to, the touch screen 2B, the button 3, the illumination sensor 4, the proximity sensor 5, the microphone 8, the camera 12, the camera 13, the acceleration sensor 15, the direction sensor 16, and the gyroscope 17.

The controller 10 executes, for example, the control program 9A to execute various controls such that the screen displayed on the display 2A is changed according to the detected gesture through the touch screen 2B.

The controller 10 executes, for example, the mail application 9B to implement the e-mail function. The controller 10 executes the browser application 9C to implement the WEB browsing function. The controller 10 executes the address book program 9D to implement the address book function. The controller 10 executes the character-input-screen control program 9E to implement the character input function. The controller 10 executes the character-input-screen control program 9E to implement, for example, a function for displaying the input character in the input-character display area of the character input screen based on a character input operation detected in the keyboard area of the character input screen. The controller 10 executes the edit-screen control program 9F to implement the edit function of the softkey object displayed on the character input screen.

The controller 10 executes the softkey display control program 9G to implement the softkey display function. The controller 10 executes the softkey display control program 9G to implement functions such as a function for displaying a softkey object in the softkey display area of the character input screen and the edit screen, a function for executing an application associated with a softkey object included in the character input screen, and a function for changing a configuration of the softkey objects displayed in the softkey display area of the character input screen and the edit screen. The controller 10 executes the softkey display control program 9G to implement a function for reflecting the execution result of the edit process executed on the edit screen in the softkey objects included in the edit screen and in the softkey objects included in the character input screen.

The controller 10 concurrently executes the applications (programs) using a multitask function provided by the control program 9A. For example, the controller 10 concurrently executes the character-input-screen control program 9E and the softkey display control program 9G to perform processes on the input-character display area, the softkey display area, and the keyboard area on the character input screen. The controller 10 concurrently executes the edit-screen control program 9F and the softkey display control program 9G to perform processes on the softkey display area of the edit screen.

The camera 12 is an in-camera for photographing an object facing the front face 1A. The camera 13 is an out-camera for photographing an object facing the back face 1B.

The connector 14 is a terminal to which other device is connected. The connector 14 may be a general-purpose terminal such as a Universal Serial Bus (USB), a High-Definition Multimedia Interface (HDMI), Light Peak (Thunderbolt), and an earphone/microphone connector. The connector 14 may be a dedicated terminal such as a dock connector. Examples of the devices connected to the connector 14 include, but are not limited to, an external storage device, a speaker, and a communication device.

The acceleration sensor 15 detects a direction and a magnitude of acceleration applied to the smartphone 1. The direction sensor 16 detects a direction of geomagnetism. The gyroscope 17 detects an angle and an angular velocity of the smartphone 1. The detection results of the acceleration sensor 15, the direction sensor 16, and the gyroscope 17 are used in combination with each other in order to detect a position of the smartphone 1 and a change of its attitude.

Part or all of the programs and the data stored in the storage 9 in FIG. 6 may be downloaded from any other device through communication by the communication unit 6. Part or all of the programs and the data stored in the storage 9 in FIG. 6 may be stored in the non-transitory storage medium that can be read by the reader included in the storage 9. Part or all of the programs and the data stored in the storage 9 in FIG. 6 may be stored in the non-transitory storage medium that can be read by a reader connected to the connector 14. Examples of the non-transitory storage mediums include, but are not limited to, an optical disc such as CD, DVD, and Blu-ray, a magneto-optical disc, magnetic storage medium, a memory card, and solid-state storage medium.

The configuration of the smartphone 1 illustrated in FIG. 6 is only an example, and therefore it can be modified as required within a scope that does not depart from the gist of the present invention. For example, the number and the type of the button 3 are not limited to the example of FIG. 6. The smartphone 1 may be provided with buttons of a numeric keypad layout or a QWERTY layout and so on as buttons for operation of the screen instead of the buttons 3A to 3C. The smartphone 1 may be provided with only one button to operate the screen, or with no button. In the example of FIG. 6, the smartphone 1 is provided with two cameras; however, the smartphone 1 may be provided with only one camera or with no camera. In the example of FIG. 6, the smartphone 1 is provided with three types of sensors in order to detect its position and attitude; however, the smartphone 1 does not have to be provided with some of the sensors. Alternatively, the smartphone 1 may be provided with any other type of sensor for detecting at least one of the position and the attitude.

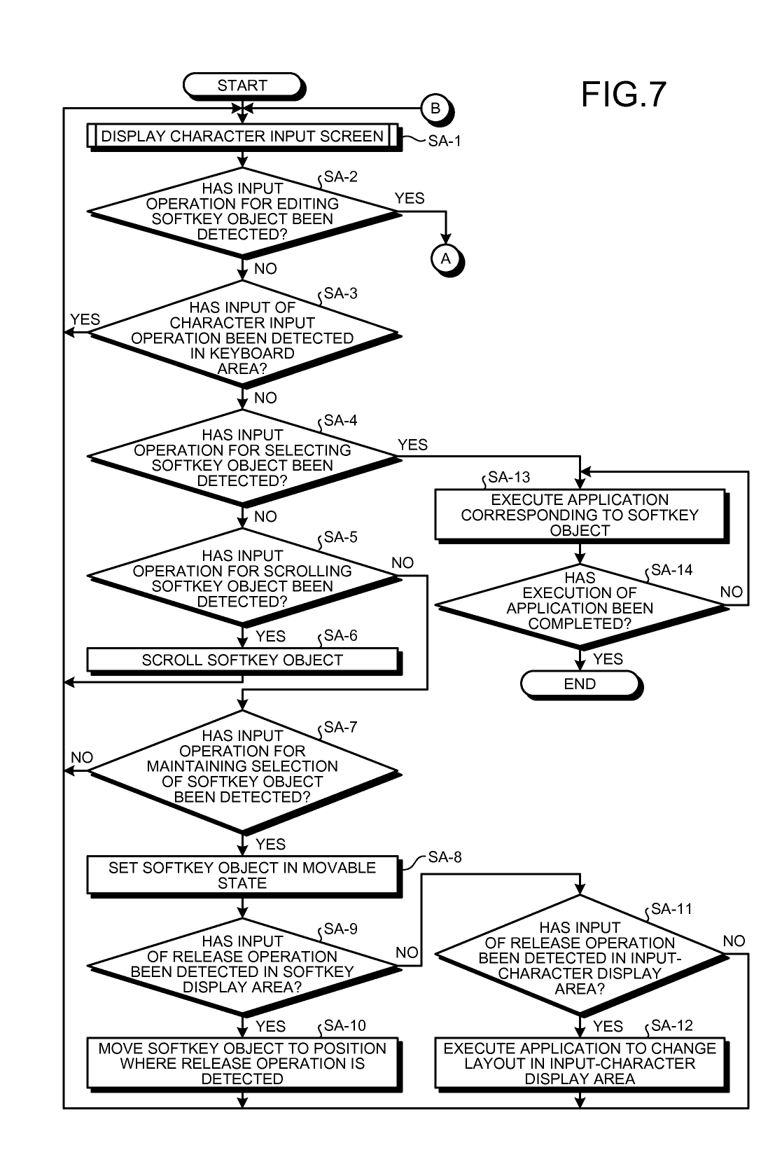

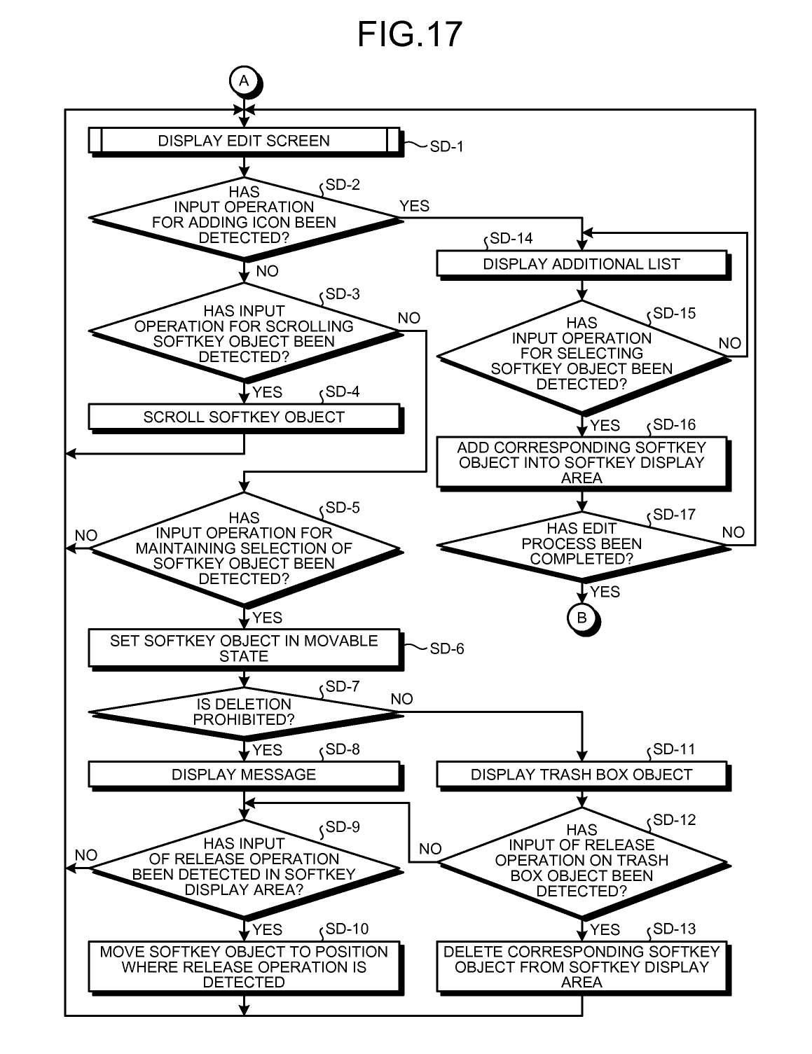

Examples of the control executed by the controller 10 of the smartphone 1 will be explained below with reference to FIG. 7 to FIG. 21. The details of a character-input-screen control process will be explained first with reference to FIG. 7 to FIG. 16, and then the details of an edit-screen control process will be explained with reference to FIG. 17 to FIG. 21.

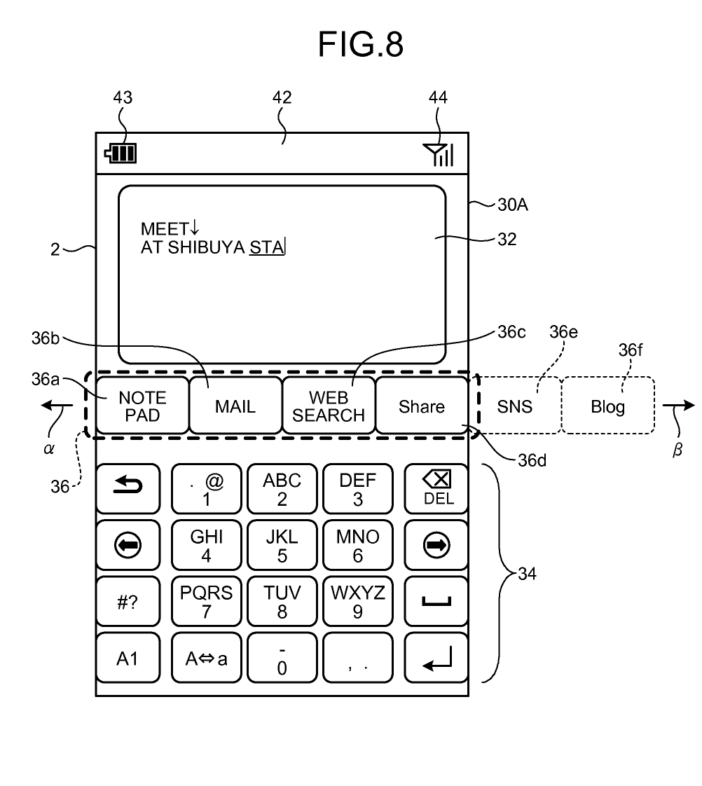

First of all, referring to the flowchart of FIG. 7, and also with reference to FIG. 8 to FIG. 12 as required, the character-input-screen control process of the smartphone 1 will be explained below. FIG. 7 is a flowchart illustrating an example of the character-input-screen control process of the smartphone 1. The procedure in FIG. 7 is repeatedly executed based on the functions provided by the character-input-screen control program 9E and the softkey display control program 9G. The processes illustrated in FIG. 7 are executed when the user previously inputs an operation for executing the character input application through the home screen or the lock screen and the controller 10 executes the character input application.

As illustrated in FIG. 7, when the character input application is executed by a user's operation, the controller 10 displays the character input screen on the display 2A (Step SA-1). At this time, the controller 10 arranges a plurality of softkey objects, in a row, associated with executions of the applications respectively, and displays part of the softkey objects arranged in a row in a belt-like softkey display area of the character input screen.

An example of the character input screen displayed on the display 2A will be explained with reference to FIG. 8. FIG. 8 is a diagram illustrating an example of the character input screen. A character input screen 30A in FIG. 8 represents a state in which text is partially input.

As illustrated in FIG. 8, the character input screen 30A includes an input-character display area 32 for recognizing an input character string, provided in a substantially whole area in the upper half of the screen; a keyboard area 34 for inputting a character string, provided in a substantially whole area in the lower half of the screen; and a softkey display area 36 for displaying part of the softkey objects 36a to 36f arranged in a row in association with executions of applications respectively, provided in the central portion of the screen. Displayed in the input-character display area 32 is a character string input by a character input operation performed on keyboard objects in the keyboard area 34. The character string displayed in the input-character display area 32 is “MEET↓ AT SHIBUYA STA|”. A down-arrow symbol “↓” indicates a line feed, and a vertical bar “|” indicate a cursor. Keyboard objects in the keyboard area 34 can be operated by tap, swipe, or so. The character input screen 30A has the area 42 the same as the area 42 of the home screen 40 provided along the top edge of the display 2A. The character input screen 30A displays the remaining mark 43 indicating a remaining amount of a power supply and the radio-wave level mark 44 indicating an electric field strength of radio wave for communication on the area 42.

In the present embodiment, the softkey display area 36 is a belt-like area extending in the horizontal direction as indicated by a dotted line portion between the input-character display area 32 and the keyboard area 34. The softkey display area 36 displays a plurality of softkey objects 36a, 36b, 36c, and 36d. As illustrated in FIG. 8, the softkey objects 36e and 36f are not actually displayed in the softkey display area 36. The softkey objects 36e and 36f are displayed when an operation for moving softkey objects displayed in the softkey display area 36 is input by the user and the softkey objects displayed in the character input screen 30A are thereby scrolled. When an input such as a flick in an “α” direction (first edge side) or in a “β” direction (second edge side) is detected in the softkey display area 36 of the character input screen 30A, the smartphone 1 displays the non-displayed softkey objects 36e and 36f in the softkey display area 36. That is, in the present embodiment, the softkey objects 36a to 36f are arranged in a row in order of the softkey objects 36a, 36b, 36c, 36d, 36e, and 36f. When an operation for moving the softkey objects is input by the user, the softkey objects are scrolled in the softkey display area 36. Of the softkey objects 36a to 36f, the softkey object 36a and the softkey object 36f may be provided so as to be virtually adjacent to each other. Namely, in the present embodiment, the softkey objects 36a to 36f may be arranged so as to be circularly displayed in the softkey display area 36. Operations performed on the softkey display area 36 will be explained later.

In the present embodiment, the softkey objects 36a to 36f displayed in the softkey display area 36 are associated with applications that can work with the character input function respectively. That is, in the present embodiment, each of the applications respectively associated with the softkey objects 36a to 36f is an application capable of using a character string displayed in the input-character display area 32 of the character input screen 30A. The softkey object 36a is an image including a character string “NOTE PAD”, which is a shortcut for executing a text editor application. The softkey object 36b is an image including a character string “MAIL”, which is a shortcut for executing the mail application. The softkey object 36c is an image including a character string “WEB SEARCH”, which is a shortcut for executing the browser application to display a predetermined search engine. The softkey object 36d is an image including a character string “Share”, which is a shortcut for executing any application that can share information with others. The softkey object 36e is an image including a character string “SNS”, which is a shortcut for executing the browser application to display a predetermined social network service site. The softkey object 36f is an image including a character string “Blog”, which is a shortcut for executing the browser application to display a predetermined blog site. In the present embodiment, the softkey objects 36a to 36f can be operated by tap, long tap, swipe, flick, and so on. The softkey object may include an image according to an application corresponding to the softkey object. For example, the softkey object may include icon images corresponding to various mail applications.

Referring back to FIG. 7, the explanation of the processes by the controller 10 is continued. The controller 10 determines whether an operation for editing a softkey object has been detected during display of the character input screen (Step SA-2). Examples of the operation for editing the softkey object include, but are not limited to, a click on the button 3 and a touch on a specific softkey object. In other words, the controller 10 determines whether a click input on the button 3 or a touch input on a specific softkey object has been detected.

When it is determined that an input operation for editing the softkey object has been detected at Step SA-2 (Yes at Step SA-2), the controller 10 proceeds to the edit-screen control process (to the process of “A” in FIG. 7) in order to implement the edit process for the softkey object displayed on the character input screen. The details of the edit-screen control process will be explained later with reference to FIG. 17 to FIG. 21.

When it is determined that the input operation for editing the softkey object has not been detected at Step SA-2 (No at Step SA-2), the controller 10 determines whether an input of a character input operation has been detected in the keyboard area of the character input screen (Step SA-3). The character input operation includes a tap on a keyboard object in the keyboard area. Namely, the controller 10 determines whether a tap input on a keyboard object in the keyboard area has been detected.

When it is determined that the input of the character input operation has been detected at Step SA-3 (Yes at Step SA-3), the controller 10 proceeds to the process at Step SA-1, and displays the character input through the character input operation in the input-character display area.

When it is determined that the input of the character input operation has not been detected at Step SA-3 (No at Step SA-3), the controller 10 determines whether an input operation for selecting a softkey object displayed in the softkey display area has been detected (Step SA-4). The operation for selecting a softkey object displayed in the softkey display area includes a tap on a softkey object displayed in the softkey display area. That is, the controller 10 determines whether a tap input on a softkey object displayed in the softkey display area has been detected.

When it is determined that the input operation for selecting a softkey object has not been detected at Step SA-4 (No at Step SA-4), the controller 10 determines whether an input operation for scrolling softkey objects in the softkey display area has been detected (Step SA-5). The operation for scrolling softkey objects in the softkey display area includes a flick performed in the softkey display area. In other words, the controller 10 determines whether a flick input in the belt-like softkey display area has been detected.

When it is determined that the input operation for scrolling softkey objects has been detected at Step SA-5 (Yes at Step SA-5), the controller 10 moves the display positions of the softkey objects arranged in a row, displays at least one of the softkey objects not displayed in the softkey display area, and deletes at least one of the softkey objects displayed in the softkey display area (Step SA-6). Specifically, the controller 10 deletes at least one softkey object located at the first edge of the softkey display area in the moving direction of a flick, and displays at least one softkey object not displayed in the softkey display area at the second edge of the softkey display area on the opposite side to the first edge. The first edge is an edge portion nearer to an end point than a start point of a flick in the moving direction of the flick, and the second edge is an edge portion nearer to the start point than the end point of the flick in the moving direction of the flick. Thereafter, the controller 10 proceeds to the process at Step SA-1.

When it is determined that the input operation for scrolling softkey objects has not been detected at Step SA-5 (No at Step SA-5), the controller 10 determines whether an input operation for maintaining selection of a softkey object displayed in the softkey display area has been detected (Step SA-7). The operation for maintaining selection of a softkey object displayed in the softkey display area includes a long tap performed on the softkey object displayed in the softkey display area. That is, the controller 10 determines whether a long-tap input on the softkey object displayed in the softkey display area has been detected.

When it is determined that the input operation for maintaining selection of a softkey object has been detected at Step SA-7 (Yes at Step SA-7), the controller 10 sets the softkey object in a movable state (Step SA-8). When it is determined that the input operation for maintaining selection of a softkey object has not been detected at Step SA-7 (No at Step SA-7), the controller 10 proceeds to the process at Step SA-1.

After setting the softkey object in the movable state at Step SA-8, the controller 10 determines whether an input of an operation for moving the softkey object and then releasing the softkey object (a release operation) has been detected in the softkey display area (Step SA-9). The operation for moving the softkey object includes dragging the softkey object. The release operation in the softkey display area includes dropping the softkey object in the softkey display area. That is, the controller 10 determines whether a drag input on the softkey object has been detected and then a drop input in the softkey display area has been detected.

When it is determined whether an input of the release operation has been detected in the softkey display area at Step SA-9 (Yes at Step SA-9), the controller 10 changes the arrangement of the softkey objects arranged in a row so as to display the softkey object at the position where the release operation has been detected (Step SA-10). Thereafter, the controller 10 proceeds to the process at Step SA-1.

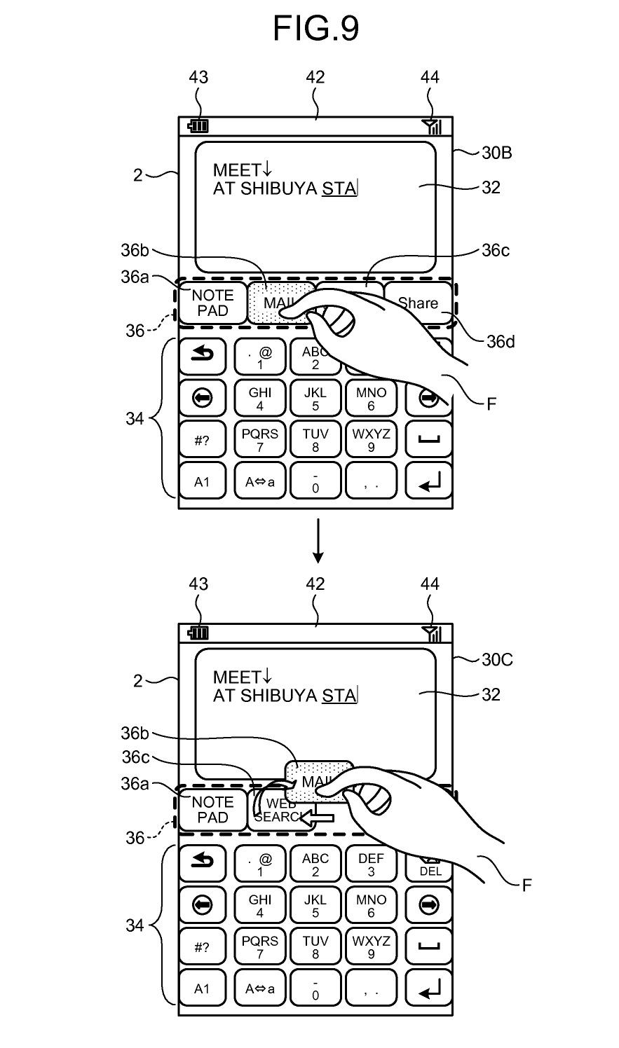

An example of a character input screen changed through the change in the arrangement of the softkey objects performed at Step SA-7 to Step SA-10 will be explained below with reference to FIG. 9. FIG. 9 is a diagram illustrating an example of changing the arrangement of the softkey objects.

As illustrated in FIG. 9, a character input screen 30B on the upper side represents a state in which the softkey object 36b is selected by a long tap with a user's finger F. A character input screen 30C on the lower side represents a state in which the softkey object 36b in the movable state set by the long tap is moved in position between the softkey object 36c and the softkey object 36d by drag and drop. The character input screen 30C is the same as the character input screen 30A in FIG. 8 except for the displayed position of the softkey object 36b.

Referring back to FIG. 7, the explanation of the processes by the controller 10 is continued from the process at Step SA-9. When it is determined that the input of the release operation has not been detected in the softkey display area at Step SA-9 (No at Step SA-9), the controller 10 determines whether an input of the release operation for the softkey object after its movement has been detected in the input-character display area (Step SA-11). The operation for moving the softkey object includes dragging the softkey object. The release operation in the input-character display area includes dropping the softkey object in the input-character display area. That is, the controller 10 determines whether a drag input on the softkey object has been detected and then a drop input in the input-character display area have been detected.

When it is determined that the input operation has been detected in the input-character display area at Step SA-11 (Yes at Step SA-11), the controller 10 executes the application corresponding to the softkey object (Step SA-12). Thereafter, the controller 10 proceeds to the process at Step SA-1. When it is determined that the input of the release operation has not been detected in the input-character display area at Step SA-11 (No at Step SA-11), the controller 10 also proceeds to the process at Step SA-1. In this case, the softkey object is assumed to be returned to its original position.

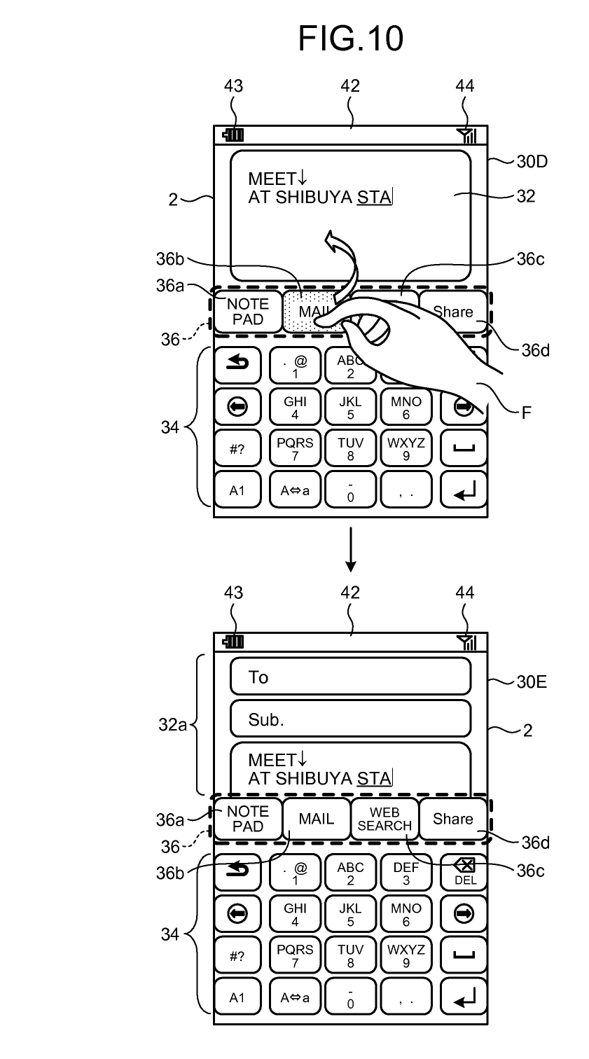

An example of changing a layout in the input-character display area by executing the application at Step SA-11 and Step SA-12 will be explained below with reference to FIG. 10. FIG. 10 is a diagram illustrating an example of changing the layout in the input-character display area by executing the application.

As illustrated in FIG. 10, a character input screen 30D on the upper side represents a state in which the softkey object 36b is selected by a long tap with the user's finger F and it is moved to the input-character display area 32 by drag and drop. A character input screen 30E on the lower side represents a state in which a layout in an input-character display area 32a is changed by executing the mail application associated with the softkey object 36b. The input-character display area 32a includes a destination address input box for entering a destination address in the upper portion of the area, a subject input box for entering a subject in the central portion of the area, and a body input box for entering a mail body in the lower portion of the area. Displayed in the body input box is the character string displayed in the input-character display area 32 of the character input screen 30D. The character input screen 30E is the same as the character input screen 30A in FIG. 8 except for the input-character display area 32a.

Referring back to FIG. 7, the explanation of the processes by the controller 10 is continued from the process at Step SA-4. When it is determined that the input operation for selecting a softkey object displayed in the softkey display area has been detected at Step SA-4 (Yes at Step SA-4), the controller 10 executes the application corresponding to the softkey object (Step SA-13). The execution of an application is such that the display is changed from the character input screen displayed on the display 2A to an operation screen for executing an application associated with the softkey object. When a character string is displayed in the input-character display area of the character input screen, the controller 10 executes the application using the character string. The execution of an application includes an execution of an application which can work with character input on the character input screen, and an execution of a process which can be executed by the application.

For example, when the softkey object 36a in FIG. 8 is selected, the controller 10 executes the text editor application and performs the process for creating a memo using the character string displayed in the input-character display area 32 of the character input screen. When the softkey object 36b in FIG. 8 is selected, the controller 10 executes the mail application and performs the process for composing a mail using the character string displayed in the input-character display area 32. When the softkey object 36c in FIG. 8 is selected, the controller 10 executes the browser application and performs the process for searching for information corresponding to the character string displayed in the input-character display area 32. When the softkey object 36d in FIG. 8 is selected, the controller 10 performs the process for displaying a list of applications that can share information with others.

When executing an application such as the mail application associated with the softkey object and transferring the input character string to the application, the controller 10 temporarily holds the input character string in the storage area, and ends the character input application in execution. When an input operation performed on a back button such as the button 3A or on a cancel button object on the screen of the application is detected during execution of the application, the controller 10 returns to an execution status of the character input application last executed, and re-displays the character string temporarily held in the storage area. This allows the user to select a desired softkey object by using the character string which is partially input. For example, even if the user selects an unintended application due to an erroneous operation, he/she can again select the softkey object associated with the desired application using the character string being input on the character input application. Alternatively, even if an input operation performed on the back button such as the button 3A or on the cancel button object on the screen of the application is detected, the controller 10 may be configured so that its status cannot be returned to the execution status of the character input application last executed.

When detecting an input operation for selecting a softkey object while nothing is input or only space or line feed is displayed in the input-character display area 32 (that is, no character string is input), the controller 10 displays a message such as an error message (e.g., “The input character is invalid, so the application cannot be activated”) and controls and does not execute the application.

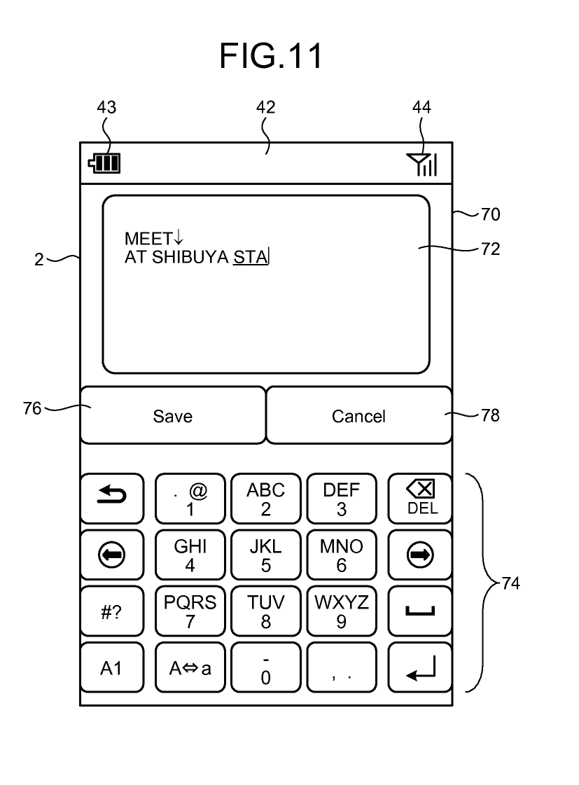

FIG. 11 depicts an example of an operation screen when the text editor application corresponding to the softkey object 36a is executed and the process of creating a memo is executed by using the character string displayed in the input-character display area 32 of the character input screen. FIG. 11 is a diagram illustrating an example of the operation screen when the text editor application is executed. When the text editor application is executed, the smartphone 1 displays an operation screen 70 illustrated in FIG. 11 on the display 2A. The operation screen 70 in FIG. 11 has a display area 72 for checking an input character string, displayed in substantially whole area of the upper half portion of the screen; keyboard objects 74 for inputting a character string, displayed in the lower half portion of the screen; a save button 76 for saving the character string displayed in the display area 72 as a new memo, displayed on the left side in a substantially central portion between the display area 72 and the keyboard objects 74; and a cancel button 78 for canceling the process of the text editor, displayed on the right side in the central portion. The operation screen 70 has the area 42 the same as the area 42 of the home screen 40 provided along the top edge of the display 2A. The operation screen 70 displays the remaining mark 43 indicating a remaining amount of a power supply and the radio-wave level mark 44 indicating an electric field strength of radio wave for communication on the area 42. When a tap or a swipe performed on the keyboard object 74 is detected while displaying the operation screen 70, the smartphone 1 detects a character corresponding to a tapped area or to a locus by the swipe as input character. The smartphone 1 displays the input character at a set position of the display area 72. When a tap on the save button 76 or the cancel button 78 is detected while displaying the operation screen 70, the smartphone 1 executes the process associated with the tapped button. The smartphone 1 executes various processes of the text editor application and detects an input of text in the above manner.

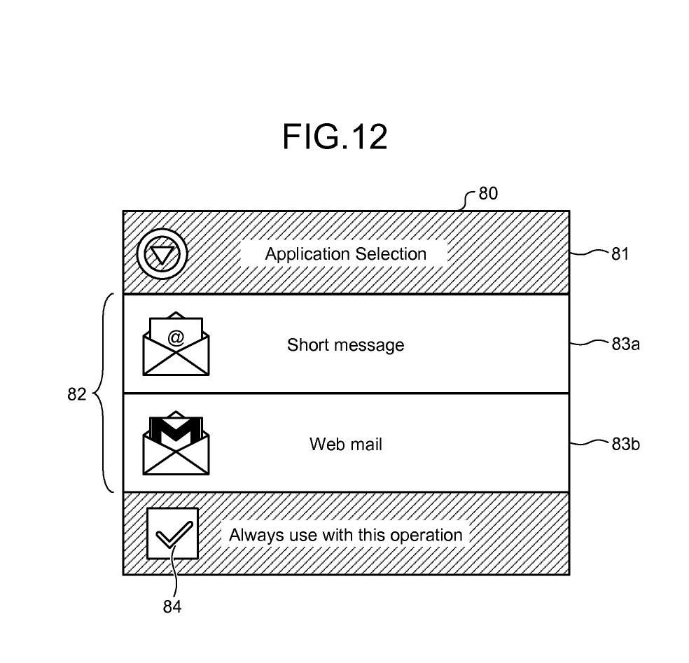

FIG. 12 depicts an example of the operation screen when the controller 10 executes the process for displaying a list of mail applications corresponding to the softkey object 36b. FIG. 12 is a diagram illustrating an example of the operation screen including the list of the mail applications. When the softkey object 36b is selected, the smartphone 1 displays an operation screen 80 illustrated in FIG. 12 on the display 2A. The operation screen 80 in FIG. 12 has a message area 81 for displaying a message indicating that the applications can be selected, displayed in the upper portion of the screen; a list area 82 for displaying icons of the mail applications associated with corresponding messages describing the icons respectively, displayed in the central portion of the screen; and a check box 84 for setting an application to be used when the softkey object 36b is selected, displayed in the lower portion of the screen. In the example of FIG. 12, the list area 82 includes a list item 83a of a short message application and a list item 83b of a Web mail application. For example, when an input operation for selecting the list item 83a from the operation screen 80 is detected, the smartphone 1 executes the process for composing a short message using the character string displayed in the input-character display area 32 of the character input screen. When an input operation for selecting the list item 83b from the operation screen 80 is detected, the smartphone 1 executes the process for composing a Web mail using the character string displayed in the input-character display area 32 of the character input screen. An operation for selecting each of the list item 83a and the list item 83b from the operation screen 80 includes a touch performed on the list item 83a or 83b. That is, when a touch input on the list item 83a or 83b is detected, the controller 10 executes the process corresponding to the list item using the character string displayed in the input-character display area 32 of the character input screen.

Referring back to FIG. 7, the explanation of the processes by the controller 10 is continued. The controller 10 executes the application corresponding to the softkey object at Step SA-13, and then determines whether the execution of the application has been completed (Step SA-14). The controller 10 determines whether the execution of the application has been completed based on the determination as to whether a completion operation for the execution of the application has been detected. The completion operation for the execution of the application includes a click on the button 3 or a touch on a predetermined icon displayed on the operation screen.

When it is determined that the execution of the application has not been completed at Step SA-14 (No at Step SA-14), the controller 10 proceeds to the process at Step SA-13, and repeats the process until it is determined that the execution of the application has been completed at Step SA-14.

When it is determined that the execution of the application has been completed at Step SA-14 (Yes at Step SA-14), the controller 10 then ends the present character-input-screen control process. The completion of the execution of the application includes, for example, in the case of the mail application, a completion of mail transmission or a completion of text storage. The controller 10 then executes the various processes provided in the smartphone 1. Specifically, the controller 10 executes a process (e.g., execution of an application corresponding to an icon displayed on the home screen, phone call, capture of images) corresponding to an operation detected by the touch screen 2B or by the button 3. When it is determined that the execution of the application has been completed at Step SA-14, the controller 10 may proceed to the process at Step SA-1 at which the character input screen is displayed, instead of completing the present character-input-screen control process.

As explained above, according to the present embodiment, the user can select any of the softkey objects arranged in the belt-like softkey display area on the character input screen by a touch, can scroll the softkey objects by a flick, and can rearrange the softkey objects by a long tap. In other words, according to the present embodiment, the softkey objects of the associated applications can be displayed in a belt-like form of list in the central portion of the screen, each of the softkey objects can be selected by a short press, and the softkey objects can be rearranged by a long press. According to the present embodiment, the operability of the character input screen can thereby be improved.

Moreover, according to the present embodiment, by dropping a softkey object in the input-character display area, it is possible to execute an application corresponding to the softkey object and customize only the input-character display area to a layout according to the application. For example, by dropping the softkey object associated with the mail application in the input-character display area, it is possible to execute the mail application and change the input-character display area to a layout including an address, a subject, and a body. In other words, according to the present embodiment, the layout in the input-character display area of the character input screen can be customized according to an application corresponding to a softkey object.

In the present embodiment, as illustrated in FIG. 8 to FIG. 10, the softkey display area is arranged in a belt-like area extending in the horizontal direction between the input-character display area and the keyboard area; however, the arrangement of the softkey display area is not limited thereto. For example, when the orientation of the character input screen is horizontal, the softkey display area may be provided in a belt-like area extending in the vertical direction on the left side or the right side of the screen. In this case, the shape of each of the softkey objects displayed in the softkey display area may be formed to a vertically long shape.

In the present embodiment, the softkey object may be a shortcut for executing an application that can work with character input on the character input screen, or may be a shortcut for executing a specific process executable by the application. For example, the softkey object may be a shortcut for executing a specific process for executing the mail application, reading the address book data 9H, and transmitting mail to a predetermined address. The softkey object may be a shortcut for executing a specific process for transmitting mail further including a predetermined message previously registered. In the present embodiment, when, for example, a double-tap input on a softkey object is detected, the controller 10 may display a submenu of the application corresponding to the softkey object as a pull-down menu.

The controller 10 of the smartphone 1 may change the configuration of the softkey objects to be displayed in the softkey display area, based on the text displayed in the input-character display area. For example, when a line feed character is included in the input-character display area, the controller 10 may delete the softkey object associated with the browser application for displaying microblogs such as Twitter from the softkey display area. Alternatively, the controller 10 may change softkey objects to be displayed in the softkey display area according to the attribute of text and the number of characters displayed in the input-character display area. For example, when the number of characters in the input-character display area becomes a predetermined threshold or more, the controller 10 may delete the softkey object associated with short message service (SMS) from the softkey display area.

As explained above, according to the present embodiment, when the character input screen is displayed, the configuration of the softkey objects displayed in the softkey display area can automatically be changed according to the attribute of the character input or the number of characters input. For example, when a line feed is input in the character input screen, the softkey object associated with the browser application for displaying microblogs such as Twitter can be deleted. That is, according to the present embodiment, the arrangement of the softkey objects can automatically be adjusted according to how characters are input. Consequently, the controller 10 of the smartphone 1 changes the configuration of the softkey objects to be displayed based on the input character, to enable display of only a softkey object which can be used. This allows the user to prevent any operation that he/she cannot execute from being input and also allows the user to intuitively understand the application or the function that can be used for the input character.

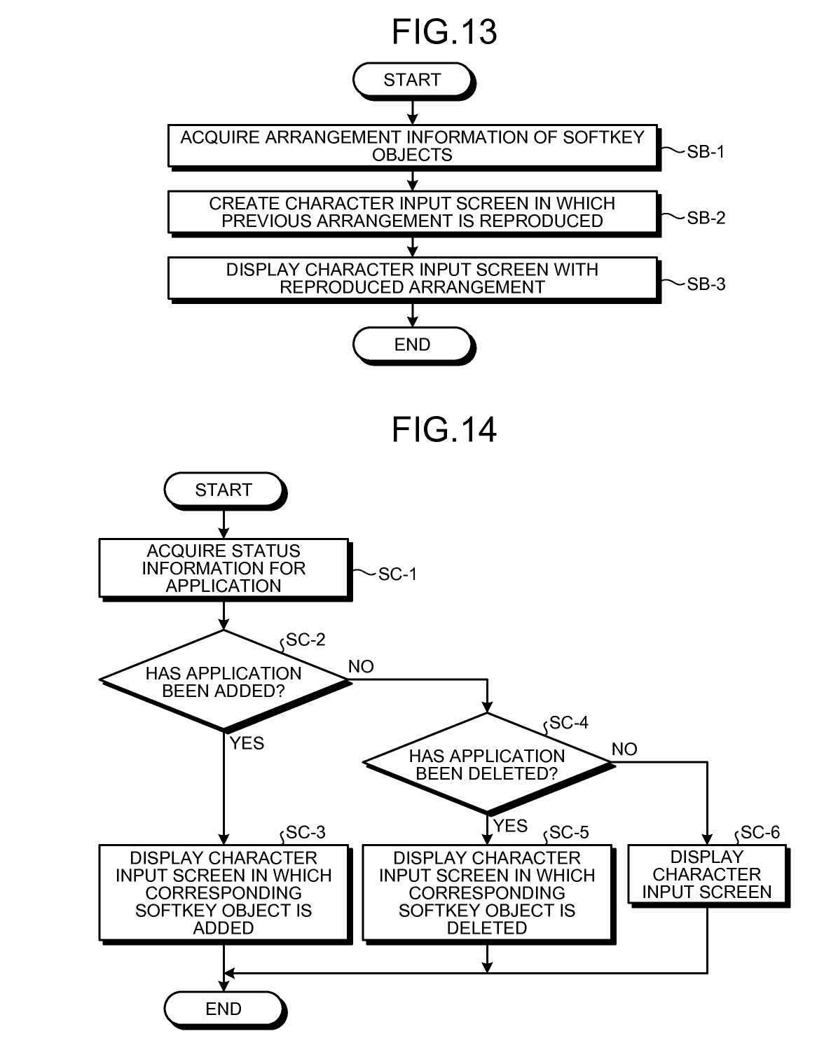

Then an example of a character-input-screen display process executed by the smartphone 1 will be explained with reference to FIG. 13. FIG. 13 is a flowchart illustrating an example of the character-input-screen display process. The flowchart in FIG. 13 explains the detail of the character-input-screen display process executed by the controller 10 at Step SA-1 in FIG. 7. The procedure in FIG. 13 is executed based on the functions provided by the character-input-screen control program 9E and the softkey display control program 9G.

As illustrated in FIG. 13, the controller 10 of the smartphone 1 acquires arrangement information for softkey objects to be displayed in the softkey display area from the softkey arrangement information file 9L of the storage 9 (Step SB-1). In the present embodiment, the arrangement information is position data indicating an arrangement of the softkey objects displayed in the softkey display area. In the present embodiment, it is assumed that the position data of the softkey objects displayed in the softkey display area is stored in the softkey arrangement information file 9L when the application corresponding to the softkey object selected by the user is executed at Step SA-13 in FIG. 7.

The controller 10 creates a character input screen, in which arrangement of the softkey objects displayed in the softkey display area right before the application is executed (corresponding to Step SA-13 in FIG. 7) is reproduced, based on the arrangement information acquired from the softkey arrangement information file 9L at Step SB-1 (Step SB-2).

The controller 10 displays the character input screen with the arrangement reproduced at Step SB-2 on the display 2A (Step SB-3). Thereafter, the controller 10 ends the present character-input-screen display process and proceeds to the process at Step SA-2 in FIG. 7.

As explained above, according to the present embodiment, when the character input screen is changed to another screen and then the character input screen is displayed, the controller 10 of the smartphone 1 can display the character input screen, in which the arrangement of the softkey objects displayed in the softkey display area right before the application is executed is reproduced, on the display 2A based on the arrangement information stored in the softkey arrangement information file 9L of the storage 9. This allows the user to select, when a softkey object is again selected on the character input screen, the softkey object from the softkey objects displayed when they are previously used, thus further improving the customer convenience of the character input screen.

Then another example of the character-input-screen display process executed by the smartphone 1 will be explained with reference to FIG. 14 to FIG. 16. FIG. 14 is a flowchart illustrating another example of the character-input-screen display process. The flowchart in FIG. 14 explains the detail of another example of the character-input-screen display process executed by the controller 10 at Step SA-1 in FIG. 7. The procedure in FIG. 14 is executed based on the functions provided by the character-input-screen control program 9E and the softkey display control program 9G.

As illustrated in FIG. 14, the controller 10 of the smartphone 1 acquires status information for applications provided in the smartphone 1 from the status information file 9M of the storage 9 (Step SC-1). In the present embodiment, the status information is list data indicating a status such as addition or deletion of each of the applications. In the present embodiment, when an application is added or deleted, the controller 10 updates the status information stored in the status information file 9M as required.

The controller 10 performs the process of changing the configuration of the softkey objects to be displayed in the softkey display area, as illustrated below in Steps SC-2 to SC-5, based on the status information acquired from the status information file 9M at Step SC-1.

Specifically, the controller 10 determines whether the application has been added based on the status information acquired from the status information file 9M at Step SC-1 (Step SC-2).

When it is determined that the application has been added at Step SC-2 (Yes at Step SC-2), the controller 10 displays the softkey object corresponding to the application in the softkey display area (Step SC-3). The controller 10 may display softkey objects in the softkey display area in the order of addition from the softkey object corresponding to the newly added application. The controller 10 may include an icon image corresponding to the newly added application in the corresponding softkey object. The controller 10 then ends the present character-input-screen display process and proceeds to the process at Step SA-2 in FIG. 7.

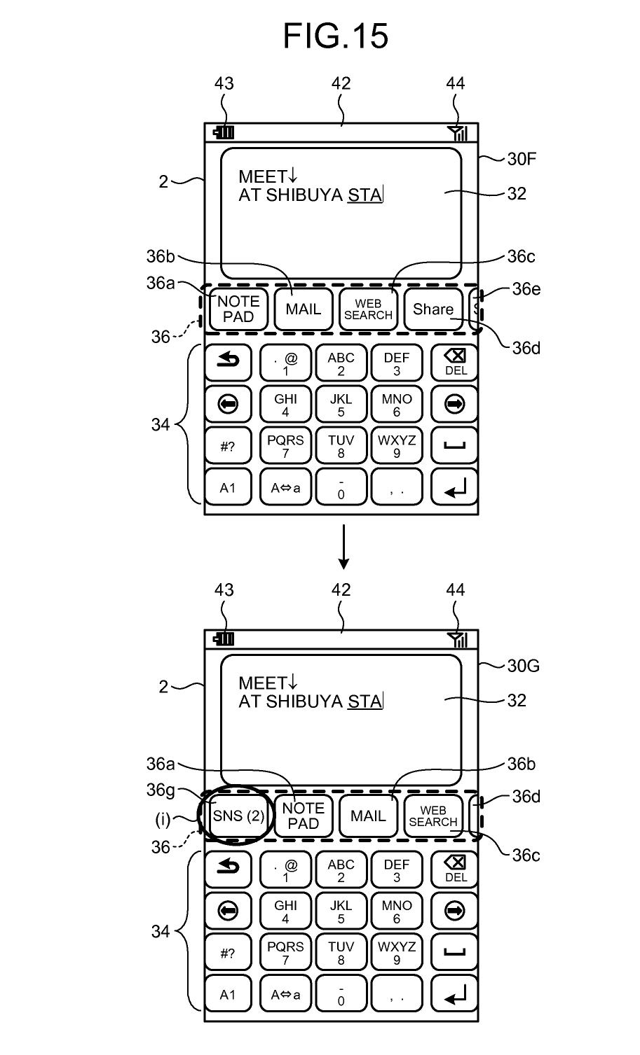

A character input screen when an application is added will be explained below with reference to FIG. 15. FIG. 15 is a diagram illustrating an example of the character input screen when an application is added. As illustrated in FIG. 15, a character input screen 30F on the upper side displays the softkey objects 36a, 36b, 36c, 36d, and 36e in the softkey display area 36. In the example of FIG. 15, when it is determined that a second SNS application, which is different from an SNS application associated with the softkey object 36e, has been added at Step SC-2, as illustrated in a character input screen 30G on the lower side of FIG. 15, the smartphone 1 adds a softkey object 36g corresponding to the second SNS application into the softkey display area 36 (see (i) in FIG. 15). The character input screen 30G is the same as the character input screen 30A in FIG. 8 except for the softkey object 36g.

Referring back to FIG. 14, the explanation of the processes by the controller 10 is continued. When it is determined that the application has not been added at Step SC-2 (No at Step SC-2), the controller 10 determines whether an application has been deleted based on the status information acquired from the status information file 9M at Step SC-1 (Step SC-4).

When it is determined that the application has been deleted at Step SC-4 (Yes at Step SC-4), the controller 10 does not display the softkey object corresponding to the application in the softkey display area (Step SC-5). The controller 10 then ends the present character-input-screen display process and proceeds to the process at Step SA-2 in FIG. 7.

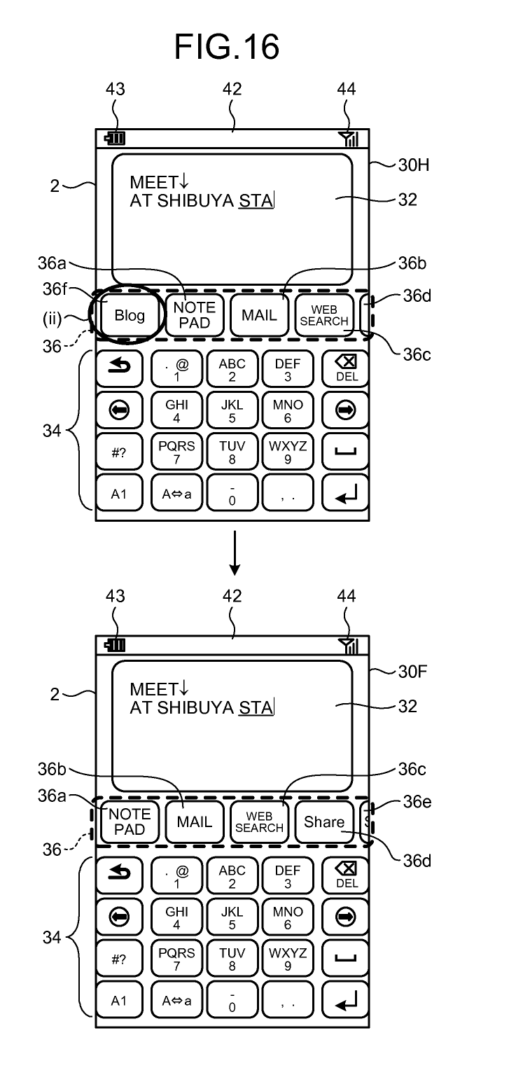

A character input screen when an application is deleted will be explained below with reference to FIG. 16. FIG. 16 is a diagram illustrating an example of the character input screen when an application is deleted. As illustrated in FIG. 16, a character input screen 30H on the upper side displays the softkey objects 36f, 36a, 36b, 36c, and 36d in the softkey display area 36. In the example of FIG. 16, when it is determined that the browser application for displaying a predetermined blog site corresponding to the softkey object 36f (see (ii) in FIG. 16) has been deleted at Step SC-4, as illustrated in a character input screen 30F on the lower side of FIG. 16, the smartphone 1 does not display the softkey object 36f in the softkey display area 36. The character input screen 30H is the same as the character input screen 30A in FIG. 8 except for the softkey object 36f that is displayed on the far left of the softkey display area 36.

Referring back to FIG. 14, the explanation of the processes by the controller 10 is continued. When it is determined that the application has not been deleted at Step SC-4 (No at Step SC-4), the controller 10 displays the usual character input screen without changing the softkey objects in the softkey display area (Step SC-6). The controller 10 then ends the present character-input-screen display process and proceeds to the process at Step SA-2 in FIG. 7.

As explained above, according to the present embodiment, the arrangement of the softkey objects in the softkey display area can automatically be adjusted according to an installation situation of an application. In the present embodiment, if a new application is installed, an image is acquired from the application, so that the image of a softkey object displayed in the softkey display area can be updated.

In the present embodiment, even if the application corresponding to the softkey object is uninstalled, the softkey object associated with the uninstalled application is not deleted from the softkey display area. In this case, when an input operation for selecting the softkey object is detected, the controller 10 displays a message or so indicating that the application cannot be activated, ends the execution of the character input application, and stops the display of the character input application. The controller 10 does not have to end the execution of the character input application and to stop the display of the character input application.

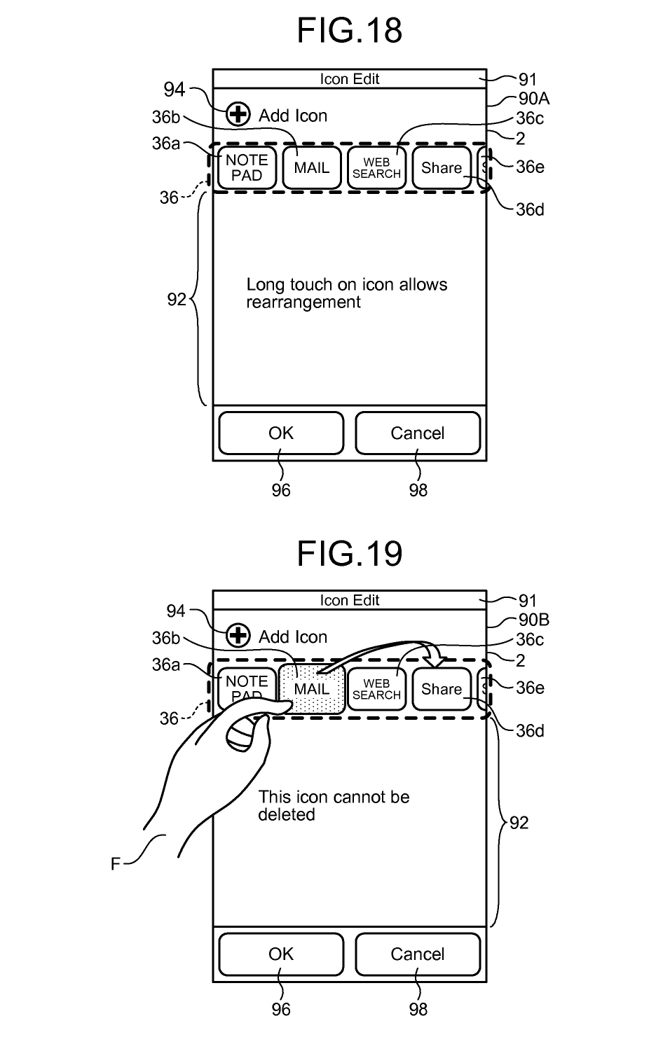

Then, referring to the flowchart of FIG. 17, and also with reference to FIG. 18 to FIG. 21 as required, an edit-screen control process of the smartphone 1 will be explained. FIG. 17 is a flowchart illustrating an example of the edit-screen control process of the smartphone 1. The procedure illustrated in FIG. 17 is repeatedly executed based on the functions provided by the edit-screen control program 9F and the softkey display control program 9G. The process illustrated in FIG. 17 is executed when the controller 10 determines that a predetermined input operation has been detected at Step SA-2 in FIG. 17.

As illustrated in FIG. 17, when an input operation for executing an edit process of a softkey object is detected during the display of the character input screen (which corresponds to “Yes at Step SA-2” in FIG. 7), the controller 10 displays the edit screen for executing the edit process of the softkey object displayed on the character input screen (Step SD-1). The edit process includes at least one of addition, deletion, and rearrangement of the softkey objects to be displayed on the character input screen. An operation for executing the edit process of the softkey object includes, for example, a click on the button 3 or a touch on a specific softkey object. In the present embodiment, when detecting an input operation for executing the edit process of the softkey object during input of text (e.g., when a cursor is displayed, that is, when there is any undetermined character), the controller 10 gives priority to the character input function and does not display the edit screen.

An example of the edit screen displayed on the display 2A will be explained below with reference to FIG. 18. FIG. 18 is a diagram illustrating an example of the edit screen. As illustrated in FIG. 18, an edit screen 90A includes the softkey objects 36a, 36b, 36c, 36d, and 36e respectively corresponding to the softkey objects 36a, 36b, 36c, 36d, and 36e included in the character input screen. That is, the edit screen 90A includes the softkey display area 36 for displaying part of the softkey objects 36a to 36f arranged in a row, similarly to the character input screen 30A in FIG. 8, in the upper portion from the substantially central portion of the screen. In other words, the controller 10 displays at least part of the softkey objects to be displayed on the character input screen in the softkey display area of the edit screen. The edit screen 90A has a message area 91 including a message indicating that this screen is provided to execute an edit process of a softkey object, displayed along the top edge of the screen; an Add Icon 94 for displaying an additional list including a new softkey object that can be added into the softkey display area 36, displayed below the message area 91; a guide message area 92 for displaying a message related to softkey objects displayed in the softkey display area 36, displayed below the softkey display area 36; a OK button 96 for completing the edit process, displayed on the left side along the bottom edge of the screen; and a cancel button 98 for canceling the edit process, displayed on the right side along the bottom edge of the screen. In the example of FIG. 18, the guide message area 92 includes a message indicating that a long touch on a softkey object displayed in the softkey display area 36 allows rearrangement (e.g., a message “Long touch on icon allows rearrangement” in FIG. 18).

Referring back to FIG. 17, the explanation of the processes by the controller 10 is continued. The controller 10 determines whether an input operation for adding an icon has been detected during the display of the edit screen (Step SD-2). That is, the controller 10 determines whether a tap on a character string “Add Icon” on the edit screen has been detected.

When it is determined that the input operation for adding an icon has not been detected at Step SD-2 (No at Step SD-2), the controller 10 determines whether an input operation for scrolling softkey objects in the softkey display area has been detected (Step SD-3). The operation for scrolling softkey objects in the softkey display area includes a flick performed in the softkey display area. That is, the controller 10 determines whether a flick input in the belt-like softkey display area has been detected.

When it is determined that the input operation for scrolling softkey objects in the softkey display area has been detected at Step SD-3 (Yes at Step SD-3), the controller 10 moves the display positions of the softkey objects arranged in a row, displays at least one of the softkey objects which have not been displayed in the softkey display area, and deletes at least one of the softkey objects which have been displayed in the softkey display area (Step SD-4). Thereafter, the controller 10 proceeds to the process at Step SD-1.

When it is determined that the input operation for scrolling softkey objects in the softkey display area has not been detected at Step SD-3 (No at Step SD-3), the controller 10 determines whether an input operation for maintaining selection of a softkey object displayed in the softkey display area has been detected (Step SD-5). The operation for maintaining selection of a softkey object displayed in the softkey display area includes a long tap performed on a softkey object displayed in the softkey display area. That is, the controller 10 determines whether a long-tap input on a softkey object displayed in the softkey display area has been detected.

When it is determined that the input operation for maintaining selection of the softkey object has been detected at Step SD-5 (Yes at Step SD-5), the controller 10 sets the softkey object in a movable state (Step SD-6). When it is determined that the input operation for maintaining selection of the softkey object has not been detected at Step SD-5 (No at Step SD-5), the controller 10 proceeds to the process at Step SD-1.

After setting the corresponding softkey object in the movable state at Step SD-6, the controller 10 determines whether the softkey object is the one of which deletion is prohibited (Step SD-7). In the present embodiment, it is previously set whether a softkey object associated with an execution of an application provided in the smartphone 1 or with an execution of a specific process that can be executed by the application can be deleted.

When it is determined that the corresponding softkey object is the one of which deletion is prohibited at Step SD-7 (Yes at Step SD-7), the controller 10 displays a message indicating that the softkey object cannot be deleted in the guide message area of the edit screen (Step SD-8).

An example of the edit screen displaying the message, displayed at Step SD-8, indicating that the corresponding softkey object cannot be deleted will be explained below with reference to FIG. 19. FIG. 19 is a diagram illustrating an example of the edit screen displaying a message indicating that the softkey object cannot be deleted. As illustrated in FIG. 19, an edit screen 90B represents a selected state of the softkey object 36b by a long tap with the user's finger F. In the present embodiment, when it is determined that the softkey object 36b is the one of which deletion is prohibit, the controller 10 displays the message indicating that the softkey object 36b cannot be deleted in the guide message area 92 of the edit screen 90B (e.g., the message indicating “This icon cannot be deleted” in FIG. 19). As illustrated in FIG. 19, because the softkey object 36b is in the selected state by the long tap with the user's finger F, the smartphone 1 can move the softkey object 36b, which is set in the movable state by the long tap, by a drag-and-drop operation at subsequent Steps SD-9 to SD-10. The edit screen 90B is the same as the edit screen 90A in FIG. 18 except for the message displayed in the guide message area 92.

Referring back to FIG. 17, the explanation of the processes by the controller 10 is continued. After displaying the message indicating that the corresponding softkey object cannot be deleted at Step SD-8, the controller 10 determines whether an input of an operation for moving the softkey object in the movable state set at Step SD-6 and then releasing the softkey object has been detected in the softkey display area (Step SD-9). The operation for moving a softkey object includes dragging the softkey object. The operation for releasing a softkey object (a release operation) in the softkey display area includes dropping it in the softkey display area. That is, the controller 10 determines whether a drag input on a softkey object has been detected and then a drop input in the softkey display area has been detected.

When it is determined that the input of the release operation has been detected in the softkey display area at Step SD-9 (Yes at Step SD-9), the controller 10 changes the arrangement of the softkey objects arranged in a row so as to display the softkey object at a position where the release operation has been detected. Thereafter, the controller 10 proceeds to the process at Step SD-1. That is, the controller 10 performs the process at Step SD-10 and then reflects the execution result of the rearrangement process of the softkey objects, which is an example of the edit process executed on the edit screen, in the softkey objects included in the edit screen displayed at Step SD-1. When it is determined that the input of the drop operation has not been detected in the softkey display area at Step SD-9 (No at Step SD-9), the controller 10 also proceeds to the process at Step SD-1. In this case, the softkey object is assumed to be returned to its original position.

Referring back to the process at Step SD-7, the explanation of the processes by the controller 10 is continued. When it is determined that the softkey object is not the one of which deletion is prohibited (No at Step SD-7), that is, when it is determined that the softkey object is the one that can be deleted, which means its deletion is not prohibited, the controller 10 displays a trash box object associated with an execution of a deletion process of the softkey object in the guide message area of the edit screen (Step SD-11).

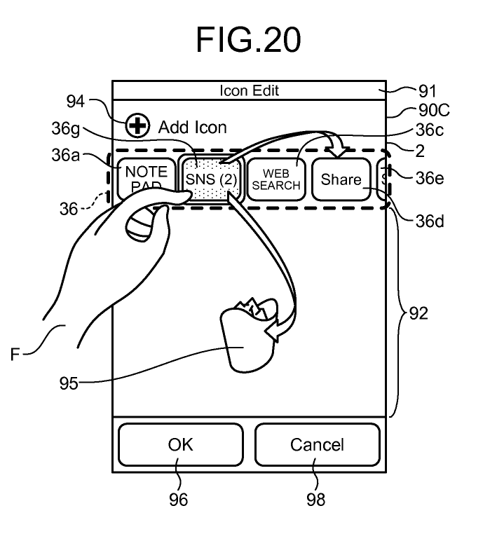

An example of the edit screen including the trash box object displayed at Step SD-11 will be explained below with reference to FIG. 20. FIG. 20 is a diagram illustrating an example of the edit screen including the trash box object. As illustrated in FIG. 20, an edit screen 90C represents a selected state of the softkey object 36g by a long tap with the user's finger F. The softkey object 36g is a shortcut for executing the second SNS application which is different from the SNS application associated with the softkey object 36e. When it is determined that the softkey object 36g is the one that can be deleted, which means its deletion is not prohibited, the controller 10 displays a trash box object 95 associated with an execution of the deletion process of the softkey object in the guide message area 92 of the edit screen 90C. The trash box object 95 is a shortcut, including an image resembling a trash box, for executing the deletion process. As illustrated in FIG. 20, because the softkey object 36g is in the selected state by a long tap with the user's finger F, the smartphone 1 can move the softkey object 36g in the movable state set by a long tap on to the trash box object 95 by a drag-and-drop operation. The smartphone 1 can also move the softkey object 36b in the movable state set by a long tap by a drag-and-drop operation. The edit screen 90C is the same as the edit screen 90A in FIG. 18 except for the trash box object 95 displayed in the guide message area 92, the softkey object 36g as a target for deletion, and the softkey object 36b which is rearranged and thereby not displayed in the softkey display area 36. In the present embodiment, the application deleted from the softkey display area is not deleted from the menu (e.g., a home screen or a launcher screen).

Referring back to FIG. 17, the explanation of the processes by the controller 10 is continued. After displaying the trash box object at Step SD-11, the controller 10 determines whether an input of an operation for moving the softkey object in the movable state set at Step SD-6 and then releasing the softkey object on the trash box object has been detected (Step SD-12). The operation for moving a softkey object includes dragging the softkey object. The release operation on the trash box object includes dropping the softkey object on the trash box object. That is, the controller 10 determines whether a drag input on a softkey object has been detected and then a drop input on the trash box object has been detected.

When it is determined that the input of the release operation on the trash box object has not been detected at Step SD-12 (No at Step SD-12), the controller 10 proceeds to the process at Step SD-9.

When it is determined that the input of the release operation on the trash box object has been detected at Step SD-12 (Yes at Step SD-12), the controller 10 deletes the corresponding softkey object from the softkey display area (Step SD-13), and then proceeds to the process at Step SD-1. That is, the controller 10 performs the process at Step SD-13 and then reflects the execution result of the deletion process of the softkey objects, which is an example of the edit process executed on the edit screen, in the softkey objects included in the edit screen displayed at the subsequent Step SD-1. In other words, the controller 10 does not display the softkey object deleted at Step SD-13 in the softkey display area at the subsequent Step SD-1.

Referring back to the process at Step SD-2, the explanation of the processes by the controller 10 is continued. When it is determined that the input operation for selecting the Add Icon on the edit screen has been detected at Step SD-2 (Yes at Step SD-2), the controller 10 displays an additional list including a new softkey object that can be added into the softkey display area (Step SD-14).

The controller 10 displays the additional list at Step SD-14 and then determines whether an input operation for selecting a softkey object included in the additional list has been detected (Step SD-15). The operation for selecting a softkey object included in the additional list includes a tap performed on a softkey object included in the additional list. That is, the controller 10 determines whether a tap on the softkey object included in the additional list has been detected.

When it is determined that the input operation for selecting a softkey object has been detected at Step SD-15 (Yes at Step SD-15), the controller 10 adds the corresponding softkey object into the softkey display area (Step SD-16). When it is determined that the input operation for selecting a softkey object has not been detected at Step SD-15 (No at Step SD-15), the controller 10 returns to the process at Step SD-14.

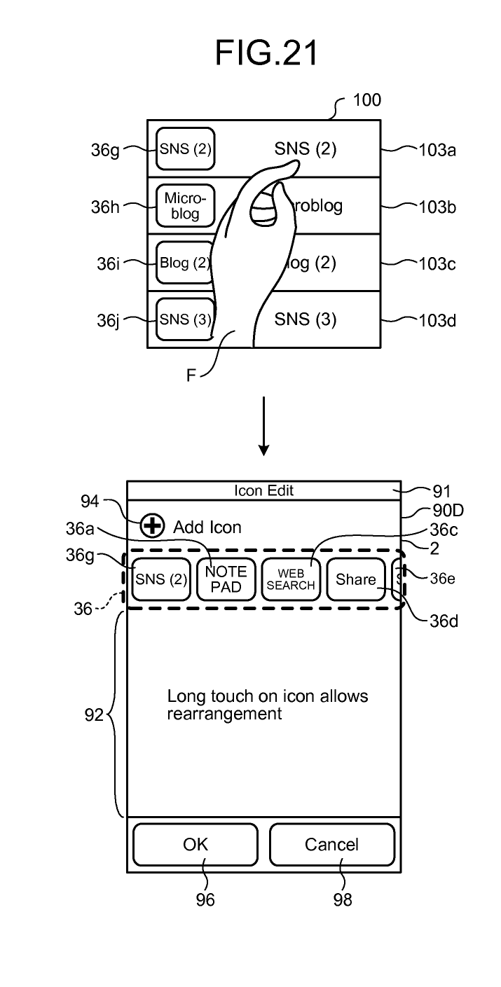

An example of the edit screen including a softkey object selected from the additional list and added at Steps SD-14 to SD-16 will be explained below with reference to FIG. 21. FIG. 21 is a diagram illustrating an example of the edit screen including the additional list and an added softkey object.

An additional list 100 on the upper side of FIG. 21 includes new softkey objects that can be added into the softkey display area 36, and list items 103a, 103b, 103c, and 103d displayed in association with messages for explaining corresponding softkey objects respectively. The list item 103a includes a new softkey object 36g associated with the second SNS application which is different from the SNS application associated with the softkey object 36e. The list item 103b includes a new softkey object 36h associated with the browser application for displaying microblogs. The list item 103c includes a new softkey object 36i associated with a browser application for displaying a second blog site which is different from the blog site associated with the softkey object 36f. The list item 103d includes a new softkey object 36j associated with a third SNS application which is different from the SNS applications associated with the softkey objects 36e and 36g.

In the example of FIG. 21, the additional list 100 represents a state in which the list item 103a including the new softkey object 36g is selected by a tap with the user's finger F. In the present embodiment, when it is determined that an input operation for selecting the Add Icon 94 on the edit screen 90A in FIG. 18 has been detected, the controller 10 displays the additional list 100 including the new softkey objects 36g, 36h, 36i, and 36j that can be added into the softkey display area 36. After the display of the additional list 100, when it is determined that an input operation for selecting the list item 103a including the softkey object 36g from the additional list 100 has been detected, the controller 10 adds the corresponding softkey object 36g to the far left in the softkey display area 36 of the edit screen 90D as illustrated in the lower side of FIG. 21. The edit screen 90D is the same as the edit screen 90A in FIG. 18 except for the softkey object 36g added thereto and the softkey object 36b not displayed in the softkey display area 36 due to the rearrangement.

In the present embodiment, the new softkey objects 36g to 36j displayed in the additional list 100 are those not displayed in the softkey display area 36. That is, the new softkey objects 36g to 36j displayed in the additional list 100 are the softkey objects being a difference as a result of subtracting the softkey objects 36a to 36f displayed in the softkey display area 36 from the softkey objects 36a to 36i corresponding to the applications that can work with the character input function installed into the smartphone 1.

In the present embodiment, the controller 10 may control so that the softkey objects already displayed in the softkey display area are grayed out on the additional list and cannot be selected. The controller 10 may display the additional list and the softkey display area at an arbitrary position on the edit screen. In this case, the user can add a desired softkey object by dragging the softkey object included in the additional list into the softkey display area. The controller 10 may previously display blank icons corresponding to the number of softkey objects that can be added into the softkey display area. In this case, the user can add a desired softkey object by dragging the softkey object included in the additional list into the blank icon.

In the present embodiment, the upper limit (e.g., 10 pieces) of the number of softkey objects that can be displayed in the softkey display area may be set. In this case, if the number exceeds the upper limit, a character string “Add Icon” displayed on the edit screen is grayed out and a softkey object cannot thereby be selected. In this case, however, if even one softkey object displayed in the softkey display area is deleted, the number does not exceed the upper limit. Therefore, the character string “Add Icon” displayed on the edit screen is reactivated and a softkey object can thereby be selected.

Referring back to FIG. 17, the explanation of the processes by the controller 10 is continued. After performing the process at Step SD-16, the controller 10 determines whether the execution of the edit process has been completed (Step SD-17). The controller 10 determines whether an input of a completion operation has been detected, and thereby determines whether the execution of the edit process has been completed. The completion operation is not limited thereto, and therefore includes a click operation on the button 3, a touch on a predetermined icon displayed on the operation screen, etc.

When it is determined that the execution of the edit process has not been completed at Step SD-17 (No at Step SD-17), the controller 10 proceeds to the process at Step SD-1. When it is determined that the execution of the edit process has been completed at Step SD-17 (Yes at Step SD-17), the controller 10 then ends the present edit-screen control process. The controller 10 proceeds to the process at Step SA-1 in FIG. 7 (see “B” in FIG. 7 and FIG. 17), and executes the character-input-screen control process. Although the example of determining whether the execution of the edit process has been completed is explained at Step SD-17, it may be determined whether the execution of the edit process has been completed by determining whether an input of the completion operation has been detected during execution of the present edit-screen control process illustrated in FIG. 17.

As explained above, according to the present embodiment, the user can add or delete any of the softkey objects to be arranged in the belt-like softkey display area by a touch and can rearrange them by a long tap even on the edit screen. That is, according to the present embodiment, the edit process (including addition, deletion, and rearrangement of the softkey objects to be displayed on the character input screen) of the softkey objects to be displayed on the character input screen can be executed. According to the present embodiment, these steps allow the user to freely set any application that can work with character input on the character input screen, thus further improving customer convenience in inputting a character.

According to the present embodiment, a softkey object corresponding to an application that can work with the character input function can be added, and a softkey object corresponding to the application installed into the smartphone 1 can also be added afterward. According to the present embodiment, the user can activate a desired application from the character input screen with a small number of steps. According to the present embodiment, when a softkey object corresponding to a desired application is to be added, it is possible to prevent that a softkey object already displayed in the softkey display area on the character input screen is erroneously added again. According to the present embodiment, a softkey object associated with an application frequently used by the user can be previously rearranged to a desired position so as to initially appear without scrolling softkey objects. According to the present embodiment, a softkey object corresponding to an application not used by the user anymore can be deleted from the character input function. As explained above, according to the present embodiment, the customer convenience in inputting a character can be dramatically improved.

In the present embodiment, at Step SD-1 in FIG. 17, the controller 10 may execute an edit-screen display process similar to the character-input-screen display process illustrated in FIG. 13 and FIG. 14. In this case, although the controller 10 performs the process on the character input screen in FIG. 13 and FIG. 14, it is assumed that the process is performed on the edit screen instead of the character input screen to execute the edit-screen display process similar to the character-input-screen display process illustrated in FIG. 13 and FIG. 14.

The embodiment disclosed in the present application can be modified without departing the gist and the scope of the invention. Moreover, the embodiments and their modifications disclosed in the present application can be combined with each other if necessary. For example, the embodiment may be modified as follows.

For example, the programs illustrated in FIG. 6 may be divided into a plurality of modules, or may be combined with any other program.

In the embodiment, the smartphone has been explained as an example of the device provided with the touch screen display; however, the device according to the appended claims is not limited to the smartphone. The device according to the appended claims may be a mobile electronic device other than the smartphone. Examples of the mobile electronic devices include, but are not limited to, mobile phones, tablets, mobile personal computers, digital cameras, media players, electronic book readers, navigators, and gaming devices. The device according to the appended claims may be a stationary-type electronic device. Examples of the stationary-type electronic devices include, but are not limited to, desktop personal computers, automatic teller machines (ATM), and television receivers.

Although the art of appended claims has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A device comprising:
a touch screen display for displaying a character input screen including a plurality of softkey objects each associated with an execution of an application; and
a controller for executing an edit process of the plurality of softkey objects displayed on the character input screen.

2. The device according to claim 1, wherein
the edit process is at least one of addition, deletion, and rearrangement of the plurality of softkey objects displayed on the character input screen.

3. The device according to claim 1, wherein
the controller is configured to display an edit screen for executing the edit process of the plurality of softkey objects displayed on the character input screen.

4. The device according to claim 3, wherein
the controller is configured to display at least part of the plurality of softkey objects, which are displayed on the character input screen, on the edit screen.

5. The device according to claim 3, wherein
the controller is configured to
display an additional list including a softkey object, which can be added as a softkey object to be displayed on the character input screen, on the edit screen, and
add, when an input operation performed on the softkey object included in the additional list is detected, the softkey object as a softkey object to be displayed on the character input screen.

6. The device according to claim 3, wherein
the controller is configured to
set, when an input operation performed on the softkey object displayed on the edit screen is detected, the softkey object in a movable state, and
change, when an input operation of moving the softkey object and then releasing the softkey object is detected, an arrangement of the plurality of softkey objects so as to display the softkey object at a position where the input operation of releasing is detected.

7. The device according to claim 3, wherein
the controller is configured to
set, when an input operation performed on the softkey object displayed on the edit screen is detected, the softkey object in a movable state,
determine whether the softkey object in the movable state is a softkey object of which deletion is prohibited, and
display, when it is determined that the softkey object in the movable state is a softkey object of which deletion is prohibited, a message indicating that the softkey object cannot be deleted on the edit screen.

8. The device according to claim 7, wherein
the controller is configured
to display, when it is determined that the softkey object in the movable state is not a softkey object of which deletion is prohibited, a trash box object associated with an execution of a deletion process of the softkey object on the edit screen, and
not to display, when an input operation for moving the softkey object onto the trash box object is detected, the softkey object as a softkey object to be displayed on the character input screen.

9. A method for controlling a device with a touch screen display, the method comprising:
displaying a character input screen including a plurality of softkey objects each associated with an execution of an application on the touch screen display; and
executing an edit process of the plurality of softkey objects displayed on the character input screen.

10. The method according to claim 9, wherein
the edit process is at least one of addition, deletion, and rearrangement of the plurality of softkey objects displayed on the character input screen.

11. A non-transitory storage medium storing therein a program for causing, when executed by a device with a touch screen display, the device to execute:
displaying a character input screen including a plurality of softkey objects each associated with an execution of an application on the touch screen display; and
executing an edit process of the plurality of softkey objects displayed on the character input screen.
